(19) United States
(12) Patent Application Publication
(10) Pub. No.: US 2024/0369883 A1
(43) Pub. Date: Nov. 7, 2024

(54) DISPLAY PANEL, MANUFACTURING METHOD AND DISPLAY DEVICE

(71) Applicants: Chengdu BOE Display Sci-tech Co., Ltd., Chengdu, Sichuan (CN); BOE TECHNOLOGY GROUP CO., LTD., Beijing (CN)

(72) Inventors: Fan LI, Beijing (CN); Kambe MAKOTO, Beijing (CN); Yong ZHANG, Beijing (CN); Lin PENG, Beijing (CN); Panqiang WU, Beijing (CN); Congcong LIU, Beijing (CN); Ju REN, Beijing (CN); Jian HAN, Beijing (CN); Jing LI, Beijing (CN); Haiwei DENG, Beijing (CN); Zhigang WANG, Beijing (CN); Lin LI, Beijing (CN)

(73) Assignees: Chengdu BOE Display Sci-tech Co., Ltd., Chengdu, Sichuan (CN); BOE TECHNOLOGY GROUP CO., LTD., Beijing (CN)

(21) Appl. No.: 18/031,540

(22) PCT Filed: Apr. 29, 2022
(86) PCT No.: PCT/CN2022/090677

§ 371 Date: Apr. 12, 2023

(51) Int. Cl. G02F 1/1337; G02F 1/1343

(52) U.S. Cl. CPC G02F 1/133746; G02F 1/134309

(57) ABSTRACT

The present disclosure provides a display panel, a manufacturing method and a display device. The display panel includes a first substrate, a second substrate and liquid crystal molecules. Each sub-pixel includes n domains, and at least two of the n domains are arranged in a first direction. An alignment film is arranged on one or both of the first substrate and the second substrate and provided with alignment directions, and/or slit electrodes each with a slit are arranged on one or both of the first substrate and the second substrate. The alignment directions in at least two adjacent domains in the n domains are different and/or extension directions of the slits in any two adjacent domains are different, so that the liquid crystal molecules in different domains are provided with different pretilt angles. The pretilt angle is an acute angle between a tilt angle of the liquid crystal molecule and a second direction, the pretilt angle is greater than or equal to 30° and smaller than 45°, and the second direction intersects the first direction. According to the present disclosure, it is able to improve the color offset.

### TECHNICAL FIELD

The present disclosure relates to the field of display technology, in particular to a display panel, a manufacturing method thereof, and a display device.

### BACKGROUND

In a liquid crystal display panel, usually each pixel electrode corresponds to a plurality of domains. The pixel electrode is provided with a slit or protrusion. In different domains, an alignment film on a substrate is provided with different alignment direction, so liquid crystal molecules in different domains have different tilt states. The liquid crystal molecules in pixels of a vertical-alignment liquid crystal display device are deflected asymmetrically, so there is color definition at left and right viewing angles, and a CR (80/20) level is poor, thereby the optical performance is adversely affected.

### SUMMARY

An object of the present disclosure is to provide a display panel, a manufacturing method and a display device, so as to improve the color offset of the display device.

The present disclosure provides the following technical solutions.

In one aspect, the present disclosure provides in some embodiments a display panel, including a first substrate and a second substrate arranged opposite to each other to form a cell, and liquid crystal molecules arranged between the first substrate and the second substrate. The display panel includes a plurality of pixel units, each pixel unit includes at least two sub-pixels in different colors, each sub-pixel includes n domains, n is a positive integer greater than or equal to 2, and at least two of the n domains are arranged in a first direction. An alignment film is arranged on one or both of the first substrate and the second substrate and provided with alignment directions, and/or slit electrodes each with a slit are arranged on one or both of the first substrate and the second substrate. The alignment directions in at least two adjacent domains in the n domains are different and/or extension directions of the slits in any two adjacent domains are different, so that the liquid crystal molecules in different domains are provided with different pretilt angles. The pretilt angle is an acute angle between a tilt angle of the liquid crystal molecule and a second direction, the pretilt angle is greater than or equal to 30° and smaller than 45°, and the second direction intersects the first direction.

In a possible embodiment of the present disclosure, the n domains are arranged sequentially along the first direction, and an acute angle between the alignment direction in each domain and the second direction is greater than or equal to 30° and smaller than 45°.

In a possible embodiment of the present disclosure, the alignment film in each domain is subjected to double exposures, an angle between an alignment direction of the alignment film formed through a first exposure of the double exposures and the second direction is 0°, and an angle between an alignment direction of the alignment film formed through a second exposure of the double exposures and the second direction is 45°.

In a possible embodiment of the present disclosure, each sub-pixel includes a first domain, a second domain, a third domain and a fourth domain arranged sequentially in the first direction, the alignment directions of at least two adjacent domains are different, and the alignment directions of the four domains are in mirror symmetry relative to a boundary line between the second domain and the third domain in the second direction.

In a possible embodiment of the present disclosure, the extension directions of the slits in any two adjacent domains in the n domains are different, an acute angle between the extension direction of the slit in each domain and the second direction is a predetermined angle greater than or equal to 30° and smaller than or equal to 45°, and an angle between the alignment direction of the alignment film in each domain and the extension direction of the slit in the domain is smaller than or equal to a predetermined value.

In a possible embodiment of the present disclosure, the predetermined value is 0° to 15°.

In a possible embodiment of the present disclosure, a first alignment film is arranged on the first substrate, a second alignment film is arranged on the second substrate, and the n domains are arranged in an M*N array in the first direction and the second direction, where M*N=n. The first alignment film is divided into N first sub-regions in the second direction, the second alignment film is divided into M second sub-regions in the first direction, the alignment directions in the N first sub-regions are the second direction, the alignment directions in the two adjacent first sub-regions are opposite to each other, the alignment directions in the M second sub-regions are the first direction, and the alignment directions in the two adjacent second sub-regions are opposite to each other, so that the first alignment film and the second alignment film are provided with different alignment directions in the n domains.

In a possible embodiment of the present disclosure, the sub-pixel includes four domains arranged in a 2*2 array in the first direction and the second direction, and the four domains include a first domain in a first row and a first column, a second domain in the first row and a second column, a third domain in a second row and the first column, and a fourth domain in the second row and the second column. A a first boundary line extending in the first direction and a second boundary line extending in the second direction are arranged among the first domain, the second domain, the third domain and the fourth domain, and the pretilt angles of the liquid crystal molecules in the first domain, the second domain, the third domain and the fourth domain are in mirror symmetry relative to the first boundary line or the second boundary line.

In a possible embodiment of the present disclosure, a first electrode is arranged on the first substrate, and a second electrode is arranged on the second substrate. The first electrode is provided with slits and at least a part of the slits extend in the second direction, and/or the second electrode is provided with slits and at least a part of the slits extend in the first direction.

In a possible embodiment of the present disclosure, the first electrode is provided with a plurality of first slits extending in a direction parallel to the alignment direction of the first alignment film and the second electrode is not provided with any slit; or the second electrode is provided with a plurality of second slits extending in a direction parallel to the alignment direction of the second alignment film and the first electrode is not provided with any slit; or the first electrode is provided with a plurality of first slits extending in a direction parallel to the alignment direction of the first alignment film, and the second electrode is provided with a plurality of second slits extending in a direction parallel to the alignment direction of the second alignment film, or the first electrode is provided with a plurality of first slits extending in a direction parallel to the alignment direction of the first alignment film and a second slit extending in a direction perpendicular to the alignment direction of the first alignment film and extending through a center of the sub-pixel, and the second electrode is not provided with any slit; or the second electrode is provided with a plurality of second slits extending in a direction parallel to the alignment direction of the second alignment film and a first slit extending in a direction perpendicular to the alignment direction of the second alignment film and extending through a center of the sub-pixel, and the first electrode is not provided with any slit, or the first electrode is provided with a plurality of first slits extending in a direction parallel to the alignment direction of the first alignment film and a second slit extending in a direction perpendicular to the alignment direction of the first alignment film and extending through a center of the sub-pixel, and the second electrode is provided with a plurality of second slits extending in a direction parallel to the alignment direction of the second alignment film and a first slit extending in a direction perpendicular to the alignment direction of the second alignment film and extending through the center of the sub-pixel; or the first electrode is provided with a plurality of first slits extending in a direction parallel to the alignment direction of the first alignment film, and the second electrode is provided with a plurality of second slits extending in a direction parallel to the alignment direction of the second alignment film and a first slit extending in a direction perpendicular to the alignment direction of the second alignment film and extending through the center of the sub-pixel.

In a possible embodiment of the present disclosure, the display panel is a vertical-alignment display panel.

In another aspect, the present disclosure provides in some embodiments a display device including the above-mentioned display panel.

In yet another aspect, the present disclosure provides in some embodiments a method for manufacturing the above-mentioned display panel. The display panel includes a plurality of pixel units, each pixel unit includes at least two sub-pixels in different colors, each sub-pixel includes n domains, n is a positive integer greater than or equal to 2, and at least two of the n domains are arranged in a first direction. The method includes: forming a first substrate and a second substrate, an alignment film being arranged on one or both of the first substrate and the second substrate and provided with alignment directions, and/or slit electrodes each with a slit are arranged on one or both of the first substrate and the second substrate; and injecting liquid crystal molecules into between the first substrate and the second substrate and enabling the first substrate to be arranged opposite to the second substrate to form a cell, to form the display panel. The alignment directions in at least two adjacent domains in the n domains are different and/or extension directions of the slits in any two adjacent domains are different, so that the liquid crystal molecules in different domains are provided with different pretilt angles. The pretilt angle is an acute angle between a tilt angle of the liquid crystal molecule and a second direction, the pretilt angle is greater than or equal to 30° and smaller than 45°, and the second direction intersects the first direction.

In a possible embodiment of the present disclosure, when the n domains are arranged sequentially in the first direction, the forming the first substrate and the second substrate specifically includes: providing a first base substrate, forming a first optical alignment material layer on the first base substrate, and subjecting each domain in the first optical alignment material layer to double exposures through polarized light so that the first optical alignment material layer forms a first alignment film with alignment directions, an angle between the alignment direction of the alignment film formed through a first exposure and the second direction being 0°, and an acute angle between the alignment direction of the alignment film formed through a second exposure and the second direction being 45°; and/or providing a second base substrate, forming a second optical alignment material layer on the second base substrate, and subjecting each domain in the second optical alignment material layer to double exposures through polarized light so that the second optical alignment material layer forms a second alignment film with alignment directions, an angle between the alignment direction of the alignment film formed through a first exposure and the second direction being 0°, and an acute angle between the alignment direction of the alignment film formed through a second exposure and the second direction being 45°.

In a possible embodiment of the present disclosure, in the first exposure, light passes through a first polarizer to form the polarized light so as to expose the first optical alignment material layer and/or the second optical alignment material layer at exposure energy of 1 Mj to 7 Mj, the first polarizer is a polarization beam splitter, and the angle between the alignment direction and the second direction is 0°. In the second exposure, light passes through a second polarizer to form the polarized light so as to expose the first optical alignment material layer and/or the second optical alignment material layer at exposure energy of 10 Mj to 30 Mj, the second polarizer is a grid-type splitting polarizer, and the angle between the alignment direction and the second direction is 45°.

The present disclosure has the following beneficial effects.

According to the display panel, the manufacturing method and the display device in the embodiments of the present disclosure, each sub-pixel in a display region is divided into a plurality of domains. At least one of the alignment direction of the alignment film on the display substrate or the extension direction of the slit in the electrode on the display substrate is improved in such a manner that the alignment directions in at least two adjacent domains in the n domains are different and/or the extension directions of the slits in any two adjacent domains are different, so as to provide the liquid crystal molecules in different domains with different pretilt angles (alignment azimuth angles). The pretilt angle is greater than or equal to 30° and smaller than 45°. As a result, it is able to improve the color offset.

### BRIEF DESCRIPTION OF THE DRAWINGS

FIG. 1 is a schematic view showing a tilt direction of slit in a sub-pixel in a pixel unit, a direction of an alignment force, and an alignment azimuth angle of a liquid crystal molecule in a conventional vertical-alignment display panel;

FIG. 2 is a schematic view showing the deflection of the liquid crystal molecules in each domain in the pixel unit in the conventional vertical-alignment display panel;

FIG. 3 is a schematic view showing an exposure and alignment process for each domain of an alignment film of a display substrate in the related art;

FIG. 4 is a schematic view showing two exposure and alignment processes for each domain of an alignment film of a color film substrate in a display panel according to one embodiment of the present disclosure;

FIG. 5 is a schematic view showing two exposure and alignment processes for each domain of an alignment film of an array substrate in the display panel according to one embodiment of the present disclosure;

FIGS. 6 to 9 are schematic views showing authentication data for authenticating a color offset improvement effect of a liquid crystal display panel in a comparative example 1, an example 1, an example 2, an example 3 and an example 4 according to one embodiment of the present disclosure, where FIG. 6 shows a color offset test result at a viewing angle of +30°, FIG. 7 shows a color offset test result at a viewing angle of −30°, FIG. 8 shows a CR (80/20) simulation test result at the viewing angle of +30°, and FIG. 9 shows a CR (80/20) simulation test result at the viewing angle of −30°;

FIG. 10 is a schematic view showing data about transmittance of the liquid crystal display panel in the comparative example 1, the example 1, the example 2, the example 3 and the example 4 according to one embodiment of the present disclosure;

FIG. 11 is a schematic view showing the deflection of liquid crystal molecules in each domain of a sub-pixel in the display panel according to one embodiment of the present disclosure;

FIG. 12 is a schematic view showing a dark line in a sub-pixel in the display panel according to one embodiment of the present disclosure;

FIG. 13 is a schematic view showing slits in each domain of a sub-pixel in the display panel according to one embodiment of the present disclosure;

FIG. 14 is a schematic view showing a CR (80/20) simulation test result of the liquid crystal display panel in a comparative example 2, a comparative example 3 and an example 5 according to one embodiment of the present disclosure;

FIG. 15 is a schematic view showing a CR (80/20) simulation test result of a liquid crystal display panel in a comparative example 4 and an example 6 according to one embodiment of the present disclosure;

FIG. 16 is a schematic view showing a CR (80/20) simulation test result of a liquid crystal display panel in a comparative example 5 and an example 7 according to one embodiment of the present disclosure;

FIG. 17 is a schematic view showing an electric field force in a second domain S2 in the pixel unit viewed along line F-F′ in FIG. 12;

FIG. 18 is a partial top view of FIG. 17;

FIGS. 19 to 34 are schematic views showing examples of a slit electrode consisting of a pixel electrode on an array substrate and a common electrode on a color film substrate according to one embodiment of the present disclosure;

FIG. 35 is a schematic view showing alignment forces and alignment azimuth angles of the liquid crystal molecules in a first substrate and a second substrate of the display panel according to one embodiment of the present disclosure;

FIG. 36 is a schematic view showing the alignment forces and slits in the first substrate and the second substrate of the display panel according to one embodiment of the present disclosure;

FIG. 37 is a left view showing a situation where the first substrate is attached to the second substrate in FIG. 36;

FIG. 38 is a front view showing a situation where the first substrate is attached to the second substrate in FIG. 36;

FIG. 39 is a schematic view showing the alignment forces, the slits and the alignment azimuth angles of the liquid crystal molecules in the first substrate and the second substrate of the display panel according to one embodiment of the present disclosure;

FIG. 40 is a left view showing a situation where the first substrate is attached to the second substrate in FIG. 39;

FIG. 41 is a front view showing a situation where the first substrate is attached to the second substrate in FIG. 39;

FIG. 42 is another schematic view showing the alignment forces, the slits and the alignment azimuth angles of the liquid crystal molecules in the first substrate and the second substrate of the display panel according to one embodiment of the present disclosure;

FIG. 43 is a left view showing a situation where the first substrate is attached to the second substrate in FIG. 42;

FIG. 44 is a front view showing a situation where the first substrate is attached to the second substrate in FIG. 42;

FIG. 45 is yet another schematic view showing the alignment forces, the slits and the alignment azimuth angles of the liquid crystal molecules in the first substrate and the second substrate of the display panel according to one embodiment of the present disclosure;

FIG. 46 is a left view showing a situation where the first substrate is attached to the second substrate in FIG. 45;

FIG. 47 is a front view showing a situation where the first substrate is attached to the second substrate in FIG. 45;

FIG. 48 is still yet another schematic view showing the alignment forces, the slits and the alignment azimuth angles of the liquid crystal molecules in the first substrate and the second substrate of the display panel according to one embodiment of the present disclosure;

FIG. 49 is a front view showing a situation where the first substrate is attached to the second substrate in FIG. 48;

FIG. 50 is still yet another schematic view showing the alignment forces, the slits and the alignment azimuth angles of the liquid crystal molecules in the first substrate and the second substrate of the display panel according to one embodiment of the present disclosure;

FIG. 51 is a front view showing a situation where the first substrate is attached to the second substrate in FIG. 50;

FIG. 52 is still yet another schematic view showing the alignment forces, the slits and the alignment azimuth angles of the liquid crystal molecules in the first substrate and the second substrate of the display panel according to one embodiment of the present disclosure;

FIG. 53 is a left view showing a situation where the first substrate is attached to the second substrate in FIG. 52;

FIG. 54 is a front view showing a situation where the first substrate is attached to the second substrate in FIG. 52;

FIG. 55 is still yet another schematic view showing the alignment forces, the slits and the alignment azimuth angles of the liquid crystal molecules in the first substrate and the second substrate of the display panel according to one embodiment of the present disclosure;

FIG. 56 is a left view showing a situation where the first substrate is attached to the second substrate in FIG. 55; and

FIG. 57 is a front view showing a situation where the first substrate is attached to the second substrate in FIG. 55.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

Before describing the schemes in the embodiments of the present disclosure, the following description about the related art will be given at first.

In the related art, liquid crystals in a liquid crystal display device do not emit light by themselves. For liquid crystal display, the deflection of liquid crystal molecules are controlled under the effect of an electric field so as to control light transmittance of a liquid crystal unit, thereby to achieve a display effect. In a Vertical-Alignment (VA) liquid crystal display device, liquid crystals exhibiting negative dielectric anisotropy are used to form the liquid crystal unit. Usually, the VA liquid crystal display device includes a color filter (CF) substrate and a thin film transistor (TFT) substrate, and a common electrode and a pixel electrode are arranged on the CF substrate and the TFT substrate respectively. At least one of the pixel electrode and the common electrode is provided with a slit, i.e., an Indium Tin Oxide (ITO) slit or protrusion.

In the case that no voltage is applied to the liquid crystal display device, the liquid crystal molecules are arranged in a direction perpendicular to the substrate, and electric signals are applied through the common electrode and the pixel electrode arranged on a color film substrate and an array substrate respectively. In the case that a voltage is applied, the liquid crystal molecules tend to arranged in a direction perpendicular to the electric field, so as to be deflected from the direction perpendicular to the substrate. A specific deflection angle is associated with a magnitude of an applied bias voltage In this way, it is able to modulate the liquid crystal molecules through a voltage signal and change a light transmission characteristic of a liquid crystal pixel, thereby to display an image.

When the liquid crystal molecule is tilted by a certain angle, different display effects are viewed by an observer at different angles, which is just called as a viewing angle problem of the liquid crystal display device. To solve this problem, for the VA liquid crystal display device, the pixel is divided into a plurality of sub-regions, i.e., a plurality of domains, in which the slits are tilted at different tilt angles, and a display characteristic of the pixel is an integral average of the domains in space. In this regard, it is able to reduce the visual difference when the image on the liquid crystal display device is viewed at different angles, thereby to improve the viewing angle problem. Usually, tilt states of the liquid crystal molecules in a pixel region are divided into at least four domains, and the tilt directions of the slits in two adjacent domains are different. The liquid crystal molecules in the pixels of the VA liquid crystal display device are deflected asymmetrically, so for the conventional liquid crystal display panel, there is obvious color offset at left and right viewing angles, and a CR (80/20) level is poor, i.e., there is a relatively large difference between an image viewed from the front and the image viewed from the side, thereby the optical performance is adversely affected.

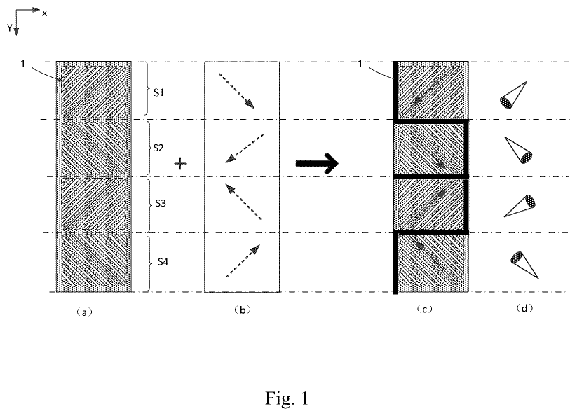

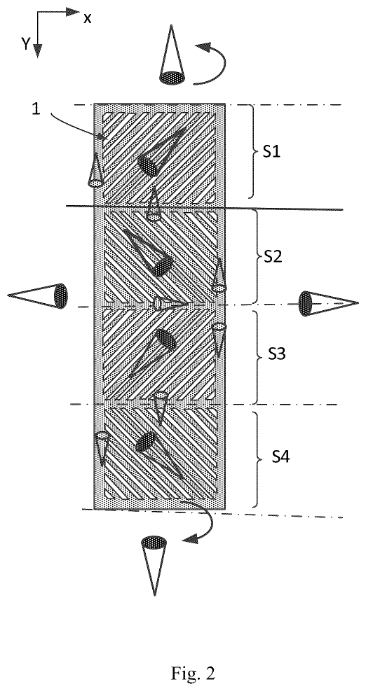

FIG. 1 shows tilt directions of slits and directions of alignment forces in one sub-pixel in the conventional VA display panel. In FIG. 1, the pixel electrode on the array substrate is a slit electrode, and one pixel is divided into four domains, i.e., a first domain S1, a second domain S2, a third domain S3 and a fourth domain S4. FIG. 1(a) shows the tilt directions of the slits 1 in each domain. It should be appreciated that, the tilt direction of the slit 1 refers to a tilt direction of the slit 1 relative to a second direction X when the four domains are arranged sequentially in a first direction Y, and the second direction X intersects the first direction Y, e.g., the second direction X is perpendicular to the first direction Y. A dotted arrow in FIG. 1(b) shows a direction of an alignment force applied by the alignment film on the common electrode of the color film substrate to the liquid crystal molecule in each domain. FIG. 1(c) shows an extension direction of the slit 1 and the direction of the alignment force applied by the alignment film in the liquid crystal display panel after the array substrate is attached to the color film substrate. FIG. 1(d) shows an alignment azimuth angle of the liquid crystal in each domain. FIG. 2 shows the deflection of the liquid crystal molecules in each domain and at a periphery. To be specific, the alignment direction of the liquid crystal molecule refers to a direction from a header of the liquid crystal molecule to a tail thereof, the header refers to a bottom surface of a cone in the figures, and the tail refers to a top of the cone in the figures. As shown in these figures, the tilt directions of the liquid crystal molecules in the domains are asymmetrical, a deflection direction of the liquid crystal molecule in each of the first domain and the fourth domain is asymmetrical with that of the liquid crystal molecule at the periphery, the liquid crystal molecule is rotated counterclockwise at a boundary line of the first domain, and the liquid crystal molecule is rotated clockwise at a boundary line of the second domain. The color offset at the left and right viewing angles may be adversely affected by a difference in a rotation angle of the liquid crystal molecule at the boundary line.

In addition, for the conventional liquid crystal display device, an alignment film is arranged at an inner surface of the array substrate and an inner surface of the color film substrate, and an alignment groove is formed in a surface of the alignment film to anchor the liquid crystal molecule and provide the liquid crystal molecule with a certain pretilt angle. In the related art, the alignment of the alignment film includes rubbing alignment and optical alignment. The optical alignment is performed on the alignment film using ultraviolet light in a non-contact manner, so no debris occurs as compared with the rubbing alignment, and no defect is caused due to electrostatic charges. In addition, the pretilt angle of the liquid crystal molecule is very small, so the image quality is excellent. Hence, the optical alignment has been more and more widely applied.

An image is generated by the liquid crystal display device through applying an electric field to a liquid crystal layer between the array substrate and an opposite substrate (e.g., the color film substrate). An alignment direction of the liquid crystal molecule in the liquid crystal layer is changed under the effect of the electric field. When the alignment direction of the liquid crystal molecule is changed, the light transmittance of the liquid crystal layer is adjusted. The liquid crystal molecule in the liquid crystal display device is pre-aligned in the alignment direction. Usually, the alignment film is arranged on one or both of the array substrate and the opposite substrate. Then, the alignment film is aligned so as to provide the alignment direction. In the optical alignment, the alignment film includes an optical alignment material. The optical alignment material is irradiated by polarized ultraviolet light to perform the alignment. In an optical alignment process, the optical alignment material absorbs the polarized ultraviolet light, and then it is decomposed or isomerized to achieve optical anisotropy, thereby to induce the liquid crystal molecule to be aligned along the alignment direction.

It is found through researches that, the alignment direction of the alignment film and the tilt direction of the slit in the conventional liquid crystal display device are both 45°. The alignment directions of the liquid crystal molecules in a same pixel are asymmetrical, so the color offset at the left and right viewing angles is poor. An object of the present disclosure is to provide a display panel, a manufacturing method and a display device, so as to improve the color offset of the display device.

The present disclosure provides in some embodiments a display panel, which includes a first substrate and a second substrate arranged opposite to each other to form a cell, and liquid crystal molecules arranged between the first substrate and the second substrate. The display panel includes a plurality of pixel units, each pixel unit includes at least two sub-pixels in different colors, each sub-pixel includes n domains, n is a positive integer greater than or equal to 2, and at least two of the n domains are arranged in a first direction. An alignment film is arranged on one or both of the first substrate and the second substrate and provided with alignment directions, and/or slit electrodes each with a slit are arranged on one or both of the first substrate and the second substrate. The alignment directions in at least two adjacent domains in the n domains are different and/or extension directions of the slits in any two adjacent domains are different, so that the liquid crystal molecules in different domains are provided with different pretilt angles. The pretilt angle is an acute angle between a tilt angle of the liquid crystal molecule and a second direction, the pretilt angle is greater than or equal to 30° and smaller than 45°, and the second direction intersects the first direction Y.

It should be appreciated that, the second direction X intersects the first direction Y. For example, the second direction X is perpendicular to the first direction Y.

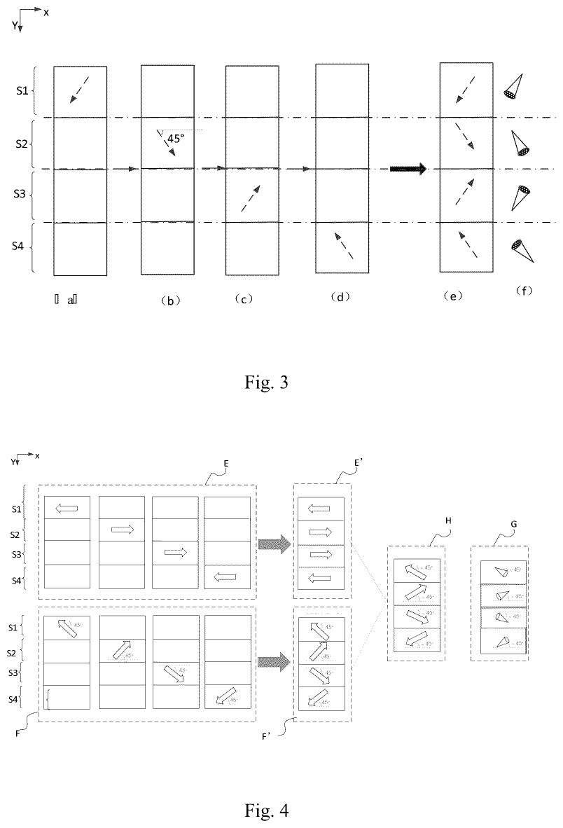

Based on the above, the sub-pixel in a display region of the display panel is divided into a plurality of domains. At least one of the alignment direction of the alignment film on a display substrate or the extension direction of the slit in the electrode on the display substrate is improved in such a manner that the alignment directions in at least two adjacent domains in the n domains are different and/or the extension directions of the slits in any two adjacent domains are different, so as to provide the liquid crystal molecules in different domains with different pretilt angles (alignment azimuth angles). The pretilt angle is greater than or equal to 30° and smaller than 45°. As a result, it is able to reduce the acute angle between the alignment direction of the liquid crystal molecule in each domain and the second direction X, thereby to improve the color offset as compared with the scheme in the related art where the pretilt angle of the liquid crystal molecule is 45°. FIG. 3 shows the deflection of the liquid crystal molecule in each domain in the pixel unit according to one embodiment of the present disclosure.

In some embodiments of the present disclosure, the pretilt angle is greater than or equal to 35° and smaller than 45°, so as to improve the color offset at left and right viewing angles of a liquid crystal display panel with the pixel units in a better manner. Furthermore, the pretilt angle is 37°, so as to achieve an optimum improvement effect of the color offset at the left and right viewing angles.

It should be appreciated that, in actual use, a specific value of the pretilt angle may be adjusted according to an actual product.

It should be further appreciated that, in some embodiments of the present disclosure, the first substrate is an array substrate, the first electrode is a pixel electrode, the second substrate is a color film substrate, and the second electrode is a common electrode.

The pretilt angle of the liquid crystal molecule is determined in accordance with the alignment direction of the alignment film on the display substrate, and the extension direction of the slit. In some embodiments of the present disclosure, the alignment directions of the alignment film in different domains on the display substrate are improved so that the pretilt angle of the liquid crystal molecule is greater than or equal to 30° and smaller than 45°.

To be specific, in some embodiments of the present disclosure, the n domains are arranged sequentially along the first direction Y, and an acute angle between the alignment direction in each domain and the second direction X is greater than or equal to 30° and smaller than 459.

When the alignment film is arranged on one or both of the first substrate and the second substrate, it means that, with respect to the alignment direction in each domain, the first substrate rather than the second substrate is provided with the alignment film; or the second substrate rather than the first substrate is provided with the alignment film, or both the first substrate and the second substrate are provided with the alignment films, and after the first substrate is attached to the second substrate, the alignment films on the first substrate and the second substrate together function to align the liquid crystal molecule in each domain.

In addition, a surface of the alignment film is provided with an alignment groove to anchor the liquid crystal molecule and provide the liquid crystal molecule with a certain pretilt angle. In the related art, the alignment of the alignment film includes rubbing alignment and optical alignment. The optical alignment is performed on the alignment film using ultraviolet light in a non-contact manner, so no debris occurs as compared with the rubbing alignment, and no defect is caused due to electrostatic charges. In addition, the pretilt angle of the liquid crystal molecule is very small, so the image quality is excellent.

Hence, in some embodiments of the present disclosure, the optical alignment is performed on the alignment film on one or both of the first substrate and the second substrate.

In the related art, when the alignment is performed on the alignment films on the array substrate and the color film substrate, the acute angle between the alignment directions and the second direction X is 45°, and the alignment directions are asymmetrical relative to each other. When the optical alignment is performed, each domain is subjected to one exposure. To be specific, an exposure process will be described as follows. An alignment material layer is formed on a base substrate, and then radiated with light passing through a polarizer for exposure. The polarizer is a Wire Grid Polarizer (WGP), which is used to directly expose the alignment material layer to form the alignment film angled by 45° relative to the second direction X. To be specific, taking the array substrate as an example, as shown in FIG. 3, there are four domains, i.e., a first domain S1, a second domain S2, a third domain S3 and a fourth domain S4. Referring to (a) to (d) in FIG. 3, each domain is subjected to one exposure for alignment using the polarized light generated by the WGP, and dotted arrows in FIG. 3 show the alignment directions of the domains, so as to finally obtain the alignment directions as shown in FIG. 3(e), where the dotted arrows indicate the alignment directions. FIG. 3(e) shows the alignment directions in the domains, and FIG. 3(f) shows the alignment azimuth angles of the liquid crystal molecules in the domains.

In the embodiments of the present disclosure, the alignment film in each domain is subjected to double exposures so as to provide the alignment direction in each domain. An angle between an alignment direction of the alignment film formed through a first exposure of the double exposures and the second direction X is 0°, and an angle between an alignment direction of the alignment film formed through a second exposure of the double exposures and the second direction X is 45°.

FIG. 4 shows the alignment on the alignment film on the array substrate through double exposures, where a dotted box E represents the first exposure in the domains, a dotted box E′ represents the alignment directions in the domains after the first exposure, a dotted box F represents the second exposure in the domains, a dotted box F′ represents the alignment directions in the domains after the second exposure, a dotted box H represents the alignment directions in the domains after the double exposures, and a dotted box G represents the alignment azimuth angles of the liquid crystal molecules in the domains after the double exposures.

As shown in FIG. 4, in a possible embodiment of the present disclosure, when a first alignment film with the alignment direction is formed merely on the first substrate through exposure, a specific exposure process will be described as follows.

At first, a first base substrate is provided, and a first optical alignment material layer is formed on the first base substrate.

Next, the first optical alignment material layer is subjected to the first exposure in each domain using the polarized light, and an angle between an alignment direction of the formed optical alignment film and the second direction X is 0°. Taking the dotted box E in FIG. 4 as an example, each sub-pixel includes four domains, i.e., the first domain S1, the second domain S2, the third domain S3 and the fourth domain S4 arranged sequentially in the first direction Y. After the first exposure, the alignment directions of the first optical alignment material layer in at least two adjacent domains are different, and the alignment directions in the four domains are in mirror symmetry relative to a boundary line between the second domain S2 and the third domain S3 in the second direction X (as shown in FIG. 4, after the first exposure, the alignment direction in the first domain S1 is opposite to that in the second domain S2, the alignment direction in the second domain S2 is identical to that in the third domain S3, and the alignment direction in the third domain S3 is opposite to that in the fourth domain S4). In the first exposure, light passes through a first polarizer to form the polarized light, and the first optical alignment material layer is radiated by the polarized light for exposure. The first polarizer is a polarization beam splitter, exposure energy is low, e.g., 1 Mj to 7 Mj (the exposure energy is appropriately set for different alignment materials), and the angle between the alignment direction and the second direction X is 0°.

Then, for the first substrate obtained after the first exposure, the first optical alignment material layer in each domain is subjected to the second exposure through polarized light, and an angle between an alignment direction of the formed optical alignment film and the second direction X is 45°. Taking the dotted box F in FIG. 4 as an example, each sub-pixel includes four domains, i.e., the first domain S1, the second domain S2, the third domain S3 and the fourth domain S4 arranged sequentially in the first direction Y. After the second exposure, the alignment directions of the first optical alignment material layer in at least two adjacent domains are different, and the alignment directions in the four domains are in mirror symmetry relative to the boundary line between the second domain S2 and the third domain S3 in the second direction X (as shown in FIG. 4, after the second exposure, the alignment direction in the first domain S1 is opposite to that in the second domain S2, the alignment direction in the second domain S2 is identical to that in the third domain S3, and the alignment direction in the third domain S3 is opposite to that in the fourth domain S4). In the second exposure, light passes through a second polarizer to form the polarized light, and the first optical alignment material layer is radiated by the polarized light for exposure. The second polarizer is a WGP, exposure energy is high, e.g., 10 Mj to 30 Mj (the exposure energy is appropriately set for different alignment materials), and the angle between the alignment direction and the second direction X is 45°.

As shown by the dotted box H in FIG. 4, a predetermined angle is formed between the alignment direction of the first alignment film on the first substrate and the second direction X after the double exposures, and the predetermined angle is greater than or equal to 30° and smaller than 45°. Under the effect of an alignment force in each domain, the pretilt angle of the liquid crystal molecule in each domain is greater than or equal to 30° and smaller than 45°.

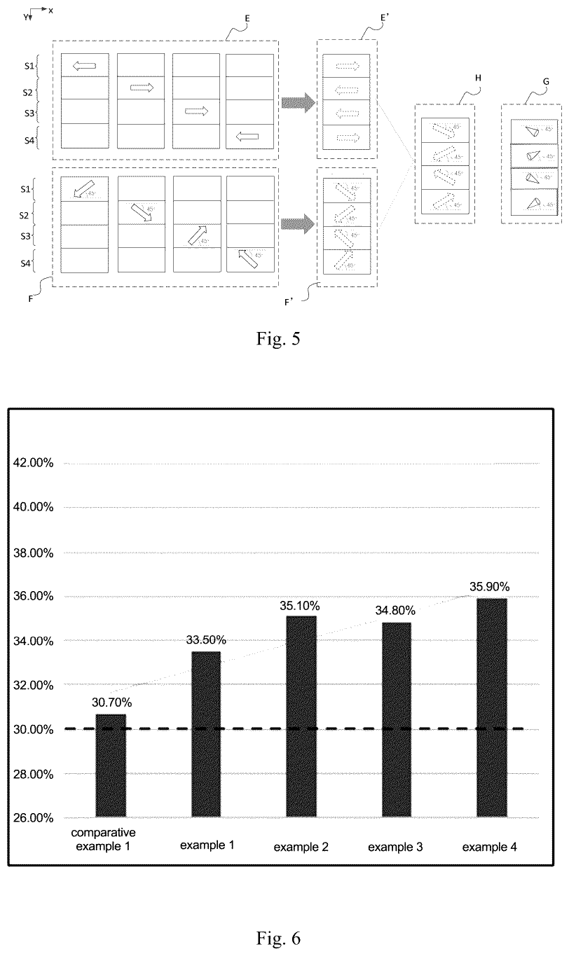

FIG. 5 shows the alignment on the alignment film on the color film substrate through double exposures, where a dotted box E represents the first exposure in the domains, a dotted box E′ represents the alignment directions in the domains after the first exposure, a dotted box F represents the second exposure in the domains, a dotted box F′ represents the alignment directions in the domains after the second exposure (in FIG. 5, the color film substrate is taken as an example, so the dotted box E and the dotted box F show a situation where the alignment film faces upward, while the dotted box E′ and the dotted box F′ show a situation where the alignment film faces downward), a dotted box H represents the alignment directions in the domains after the double exposures, and a dotted box G represents the alignment azimuth angles of the liquid crystal molecules in the domains after the double exposures.

As shown in FIG. 5, in a possible embodiment of the present disclosure, when a second alignment film with the alignment direction is formed merely on the second substrate through exposure, a specific exposure process will be described as follows.

At first, a second base substrate is provided, and a second optical alignment material layer is formed on the second base substrate.

Next, the second optical alignment material layer is subjected to the first exposure in each domain using the polarized light, and an angle between an alignment direction of the formed optical alignment film and the second direction X is 0°. As shown in FIG. 5, each sub-pixel includes four domains, i.e., the first domain S1, the second domain S2, the third domain S3 and the fourth domain S4 arranged sequentially in the first direction Y. After the first exposure, the alignment directions of the first optical alignment material layer in at least two adjacent domains are different, and the alignment directions in the four domains are in mirror symmetry relative to a boundary line between the second domain S2 and the third domain S3 in the second direction X (as shown in FIG. 5, after the first exposure, the alignment direction in the first domain S1 is opposite to that in the second domain S2, the alignment direction in the second domain S2 is identical to that in the third domain S3, and the alignment direction in the third domain S3 is opposite to that in the fourth domain S4). In the first exposure, light passes through a first polarizer to form the polarized light, and the first optical alignment material layer is radiated by the polarized light for exposure. The first polarizer is a polarization beam splitter, exposure energy is low, e.g., 1 Mj to 7 Mj (the exposure energy is appropriately set for different alignment materials), and the angle between the alignment direction and the second direction X is 0°.

Then, for the second substrate obtained after the first exposure, the second optical alignment material layer in each domain is subjected to the second exposure through polarized light, and an angle between an alignment direction of the formed optical alignment film and the second direction X is 45°. Taking the dotted box F in FIG. 5 as an example, each sub-pixel includes four domains, i.e., the first domain S1, the second domain S2, the third domain S3 and the fourth domain S4 arranged sequentially in the first direction Y. After the second exposure, the alignment directions of the first optical alignment material layer in at least two adjacent domains are different, and the alignment directions in the four domains are in mirror symmetry relative to the boundary line between the second domain S2 and the third domain S3 in the second direction X (as shown by the dotted box F′ in FIG. 5, the alignment direction in the first domain S1 is opposite to that in the second domain S2, the alignment direction in the second domain S2 is identical to that in the third domain S3, and the alignment direction in the third domain S3 is opposite to that in the fourth domain S4). In the second exposure, light passes through a second polarizer to form the polarized light, and the second optical alignment material layer is radiated by the polarized light for exposure. The second polarizer is a WGP, exposure energy is high, e.g., 10 Mj to 30 Mj (the exposure energy is appropriately set for different alignment materials), and the angle between the alignment direction and the second direction X is 45°.

As shown by the dotted boxes H and G in FIG. 5, a predetermined angle is formed between the alignment direction of the second alignment film on the second substrate and the second direction X after the double exposures, and the predetermined angle is greater than or equal to 30° and smaller than 45°. Under the effect of an alignment force in each domain, the pretilt angle of the liquid crystal molecule in each domain is greater than or equal to 30° and smaller than 45°.

It should be appreciated that, FIGS. 4 and 5 merely show the examples of the alignment directions on the first substrate and the second substrate. In some other embodiments of the present disclosure, the alignment directions on the first substrate and the second substrate may also be opposite to those as shown in FIGS. 4 and 5.

In addition, in the above-mentioned two examples, the alignment film is formed on the first substrate or the second substrate, and in some other embodiments of the present disclosure, the alignment film may also be formed on both of the first substrate and the second substrate.

For example, the first alignment film on the first substrate may be subjected to the double exposures with reference to FIG. 4, and the second alignment film on the second substrate may be subjected to the double exposures with reference to FIG. 5. It should be appreciated that, taking the alignment direction of the first alignment film on the first substrate in FIG. 4 as an example, the second alignment film on the second substrate is arranged opposite to the first alignment film on the first substrate. Hence, as shown in FIG. 5, the alignment direction of the second alignment film on the second substrate should be opposite to the alignment direction of the first alignment film, so as to ensure a same direction of the alignment forces applied by the first alignment film and the second alignment film to the liquid crystal molecules.

In the display panel according to the embodiments of the present disclosure, the alignment is performed on the alignment film through the double exposures so that the pretilt angle of the liquid crystal molecule is greater than or equal to 30° and smaller than 45°, so as to improve the color offset as compared with the related art where the pretilt angle of the liquid crystal molecule is 45°. Authentication results will be described hereinafter.

The technical effect of the display panel in the embodiments of the present disclosure will be authenticated with the conventional liquid crystal display panel as a comparative example and the liquid crystal display panel having the pixel unit in the embodiments of the present disclosure as a test example In a comparative example 1, the alignment film in the liquid crystal display panel is subjected to one exposure through polarized light generated by a WGP so that the alignment direction and the second direction is 45°. In an example 1, the alignment film on the first substrate of the display panel is subjected to the double exposures in each domain. The first exposure is performed at low exposure energy, e.g., 5 Mj, through a PBS, and the second exposure is performed at high exposure energy, e.g., 20 Mj, through the WGP. In an example 2, the alignment film on the first substrate of the display panel is subjected to the double exposures in each domain. The first exposure is performed at low exposure energy, e.g., 7 Mj, through the PBS, and the second exposure is performed at high exposure energy, e.g., 20 Mj, through the WGP. In an example 3, the alignment film on the first substrate of the display panel is subjected to the double exposures in each domain. The first exposure is performed at low exposure energy, e.g., 10 Mj, through the PBS, and the second exposure is performed at high exposure energy, e.g., 20 Mj, through the WGP. In an example 4, the alignment film on the first substrate of the display panel is subjected to the double exposures in each domain. The first exposure is performed at low exposure energy, e.g, 15 Mj, through a PBS, and the second exposure is performed at high exposure energy, e.g., 20 Mj, through the WGP.

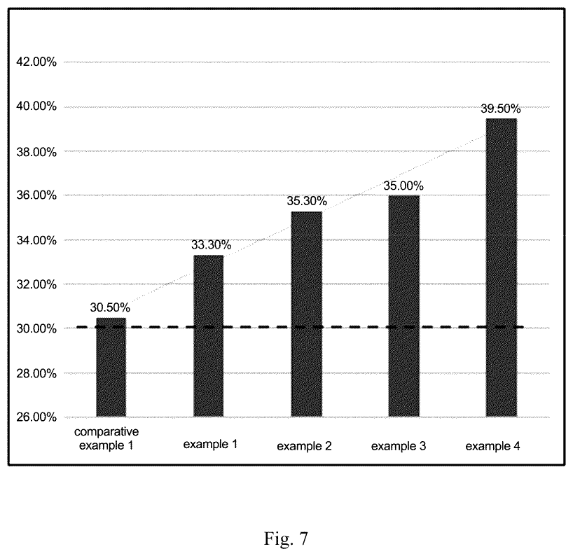

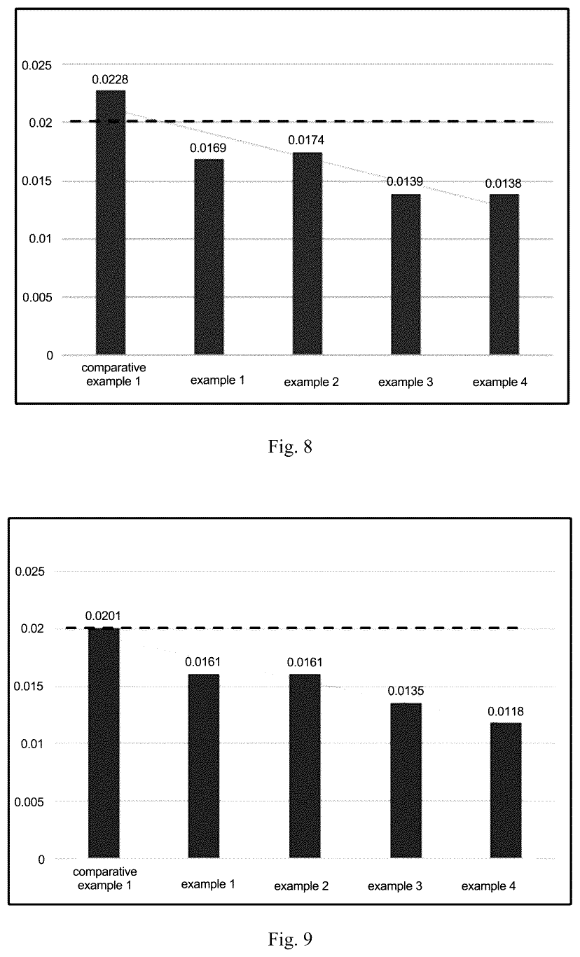

A CR (80.20)±30° simulation test is performed on the liquid crystal panels in the comparative example 1, the example 1, the example 2, the example 3 and the example 4, and FIGS. 6 to 9 show testing results thereof. FIG. 6 shows a color offset testing result obtained at a viewing angle of +30°, where a y-axis represents a color offset value. FIG. 7 shows a color offset testing result obtained at a viewing angle of −30°, where a y-axis represents a color offset value. FIG. 8 shows CR (80/20) authentication data obtained at the viewing angle of +30°. FIG. 9 shows CR (80/20) authentication data obtained at the viewing angle of −30°.

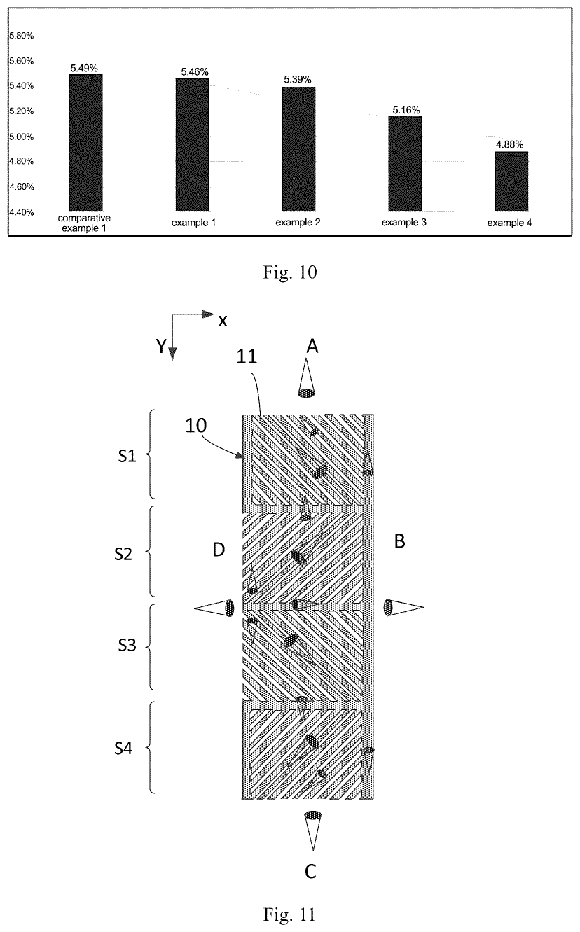

FIG. 10 shows transmittance testing results of the liquid crystal display panels in the comparative example 1, the example 1, the example 2, the example 3 and the example 4.

As shown in FIGS. 6 to 10, the color offset is obviously improved along with an increase in the exposure energy for the PBS, but the transmittance is deteriorated. When the exposure energy for the PBS is smaller than 7 Mj, the influence on the transmittance is relatively small (smaller than or equal to 2%). When the exposure energy for the PBS is 5 Mj, the influence on the transmittance is smallest (smaller than or equal to 1%), and the color offset and the CR (80/20)+30° are improved remarkably. FIG. 10 shows the transmittance transition data.

In a word, the alignment film is subjected to the first exposure through the PBS at low energy and then subjected to the second exposure through the WGP at high energy, so as to adjust the alignment azimuth angle of the liquid crystal molecule in each domain to be smaller than 45°, thereby to improve the color offset and the CR (80/20) level of the display panel. The exposure energy for the PBS is 1 Mj to 7 Mj, e.g., 3 Mj to 5 Mj, so as to remarkably improve the color offset and the CR (80/20) level while ensuring that the influence on the transmittance is smaller than or equal to 1%.

In addition, in order to further increase the transmittance, the slit electrodes each with a slit are arranged on one or both of the first substrate and the second substrate. In other words, a first electrode on the first substrate is provided with the slit, or a second electrode on the second substrate is provided with the slit, or both the first electrode and the second electrode are provided with the slits.

In addition, for example, the extension directions of the slits in any two adjacent domains in the n domains are different, an acute angle between the extension direction of the slit in each domain and the second direction X is a predetermined angle greater than or equal to 30° and smaller than or equal to 45°, and an angle between the alignment direction of the alignment film in each domain and the extension direction of the slit in the domain is smaller than or equal to a predetermined value.

Based on the above, when the pretilt angle between the extension direction of the slit in each domain and the second direction X, i.e., a tilt angle of the slit, is greater than or equal to 30° and smaller than 45°, it is able to reduce the acute angle between the alignment direction of the liquid crystal molecule in each domain and the second direction X, thereby to improve the color offset as compared with the related art where the tilt angle of the slit is 45°.

For example, the pretilt angles of the liquid crystal molecules in different domains are different, and the liquid crystal molecules in two adjacent domains are not in mirror symmetry relative to the second direction X. As shown in FIG. 11, the pixel unit is divided into four domains, i.e., the first domain S1, the second domain S2, the third domain S3 and the fourth domain S4. An alignment azimuth angle of the liquid crystal molecule in the first domain S1 is 315°, an alignment azimuth angle of the liquid crystal molecule in the second domain S2 is 45°, an alignment azimuth angle of the liquid crystal molecule in the third domain S3 is 225°, and an alignment azimuth angle of the liquid crystal molecule in the third domain S4 is 135°. To be specific, the alignment direction of the liquid crystal molecule is a direction from a header to a tail of the liquid crystal molecule, the header refers to a bottom surface of a cone in FIG. 11, and the tail refers to a top of the cone in FIG. 11.

It should be appreciated that, the so-called alignment azimuth angle of the liquid crystal molecule in the embodiments of the present disclosure refers to an angle between the alignment direction of the liquid crystal molecule and the second direction X in a counterclockwise direction. The alignment azimuth angle of the liquid crystal molecule is used to indicate a direction of an alignment force applied to the liquid crystal molecule.

For example, an angle between the alignment direction of the alignment film in each domain and the extension direction of the slit in the domain is smaller than or equal to a predetermined angle. For example, the predetermined angle is 0° to 15°. In other words, the alignment direction of the alignment film in each domain is substantially parallel to the extension direction of the slit in the domain.

In a possible embodiment of the present disclosure, the predetermined angle is 0°. In other words, the alignment direction of the alignment film in each domain is parallel to the extension direction of the slit in the domain. At this time, it is able to determine the alignment azimuth angle of the liquid crystal molecule in an easier manner, thereby to control an applied voltage in a more accurate manner.

In the embodiments of the present disclosure, the display panel is, but not limited to, a VA display panel.

In addition, in the display panel according to the embodiments of the present disclosure, when the first substrate is an array substrate, the first electrode is a pixel electrode, the second substrate is a color film substrate, and the second electrode is a common electrode. One of the pixel electrode and the common electrode is provided with the slit, and the other is not provided with any slit. Alternatively, both the pixel electrode and the common electrode are provided with the slits.

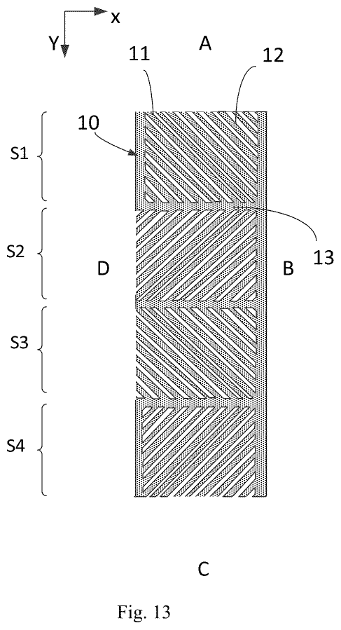

In addition, as shown in FIG. 13, in some embodiments of the present disclosure, the slit electrode 10 includes a plurality of branch electrodes arranged parallel to, and spaced apart from, each other in each domain, an inter-domain main electrode 13 is arranged between two adjacent domains and extends in the second direction X, and the branch electrodes in the two adjacent domains are in mirror symmetry relative to the inter-domain main electrode 13.

In the related art, the slit electrode 10 further includes a domain-edge main electrode 14 arranged in the domain and surrounding the branch electrodes 12. As shown in FIG. 13, the domain-edge main electrode 14 surrounds a plurality of branch electrodes 12, and functions as a boundary line of the slit electrode 10. In other words, the plurality of branch electrodes 12 does not extend to a boundary line of the slit electrode 10, and instead, the plurality of branch electrodes 12 is spaced by the boundary line by a certain distance, e.g., 5.5 μm.

It is found through researches that, in the display panel, the liquid crystal molecule in each domain is in a stable state, and a deflection of the liquid crystal molecule is controlled through adjusting a magnitude of an electric field force, so as to control display brightness. The liquid crystal molecules between the domains or at the boundary line of the domain are in an instable state, and they usually are presented in the form of a dark line. The wider the electrode at the boundary line of the domain is, the smaller the transmittance of the display panel is. For a pixel structure in the conventional display panel, the dark line is indicated by a thick line in the figures.

In order to further improve the color offset at the left and right viewing angles and increase the transmittance, in some embodiments of the present disclosure, as shown in FIG. 13, each domain includes a first side A and a second side B arranged opposite to each other in the first direction Y. The plurality of domains includes a first domain S1, a second domain S2, . . . , and an n^{th} domain arranged sequentially from the first side A to the second side B. A slit 11 in the first domain S1 extends to a boundary line at the first side A, so as to form a non-closed structure where the plurality of slits 11 and the plurality of branch electrodes 12 are arranged alternately. A slit 11 in the n^{th} domain extends to and connect to a boundary line at the second side B, so as to form a non-closed structure where the plurality of slits 11 and the plurality of branch electrodes 12 are arranged alternately.

For clarification, taking FIG. 13 as an example, the slit 11 in the uppermost first domain S1 extends to an upper boundary line of the pixel electrode, i.e., there is no domain-edge main electrode 14 at the upper boundary line. Identically, the slit in the lowermost n^{th} domain (i.e., the fourth domain S4 in FIG. 13) extends to a lower boundary line of the pixel electrode, i.e., there is no domain-edge main electrode 14 at the lower boundary line. In this way, the liquid crystal molecules in the first domain S1 and the n^{th} domain and at the upper and lower boundary line of the pixel electrode are in a more stable state under the effect of the electric field force, so as to further reduce the color offset at the left and right viewing angles.

The technical effect of the pixel unit in the embodiments of the present disclosure will be authenticated with the conventional liquid crystal display panel as a comparative example and the liquid crystal display panel having the pixel unit as a test example. In a comparative example 2, the domain-edge main electrodes 14 are arranged at the upper boundary line and the lower boundary line of the pixel electrode in the liquid crystal panel, and the tilt angle of the slit 14 is 45°. In an example 5, in the liquid crystal display panel having the pixel unit in the embodiments of the present disclosure, the slit 11 in the first domain S1 of the pixel electrode extends to the upper boundary line (i.e., there is no domain-edge main electrode 14 at the upper boundary line) and the slit 11 in the n^{th} domain extends to the lower boundary line (i.e., there is no domain-edge main electrode 14 at the lower boundary line), and the tilt angle of the slit 11 is 45°. In an example 6, in the liquid crystal display panel having the pixel unit in the embodiments of the present disclosure, the slit 11 in the first domain S1 of the pixel electrode extends to the upper boundary line (i.e., there is no domain-edge main electrode 14 at the upper boundary line) and the slit 11 in the n^{th} domain extends to the lower boundary line (i.e., there is no domain-edge main electrode 14 at the lower boundary line), and the tilt angle of the slit 11 is 40°.

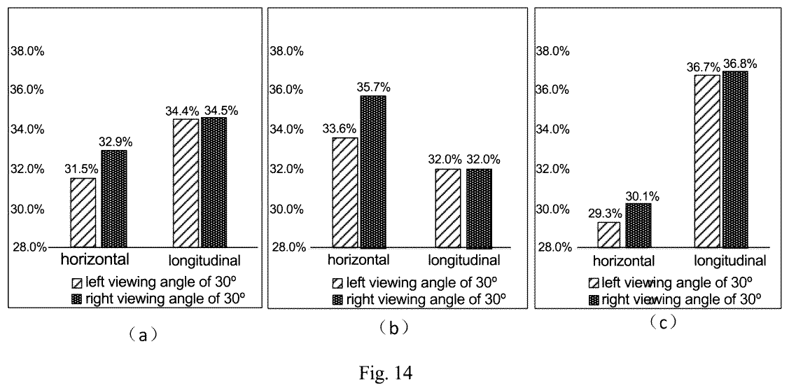

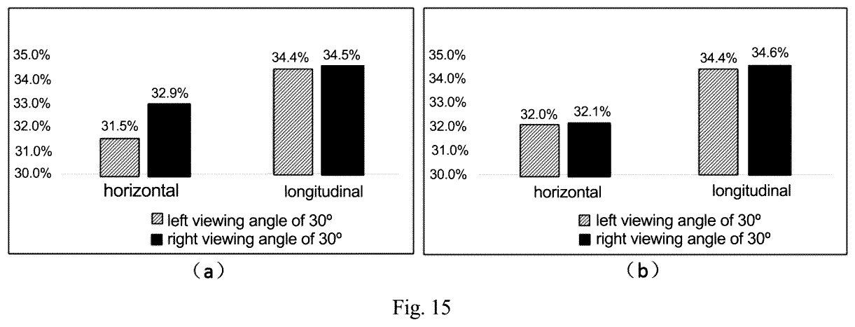

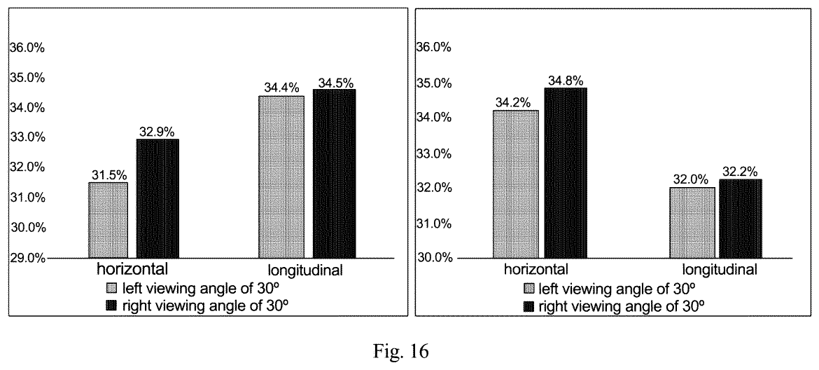

A CR (80.20) simulation test is performed on the liquid crystal panels in the comparative example 2, a comparative example 3 and the example 5, and FIG. 14 shows testing results thereof. FIG. 14(a) shows the testing result in the comparative example 2, FIG. 14(b) shows the testing result in the example 5, and FIG. 14(c) shows the testing result in the comparative example 3. A CR (80.20) simulation test is performed on the liquid crystal panels in the comparative example 2, a comparative example 3 and the example 5, and FIG. 15 shows testing results thereof. As shown in FIGS. 14 and 15, when the tilt angle of the slit 11 is optimized to 40°, the slit 11 in the first domain S1 extends to the boundary line at the first side A and the slit 11 in the n^{th} domain extends to the boundary line at the second side B, it is able to improve the color offset at the left and right viewing angles and the CR (80/20) level of the liquid crystal display panel, and meanwhile reduce a difference in the color offset at the left and right viewing angles.

It should be appreciated that, in the above-mentioned embodiments of the present disclosure, the slit 11 in the first domain S1 extends to the boundary line at the first side A, and the slit 11 in the second domain S2 extends to the boundary line at the second side B. However, in some other embodiments of the present disclosure, merely the slit 11 in the first domain S1 extends to the boundary line at the first side A, or merely the slit 11 in the second domain S2 extends to the boundary line at the second side B.

In addition, in order to increase the transmittance of the display panel as compared with that in the related art, in the embodiments of the present disclosure, for example, each domain further includes a third side and a fourth side arranged opposite to each other in the second direction X. The plurality of domains includes a first domain S1, a second domain S2, . . . , an m^{th} domain, . . . , and an n^{th} domain arranged sequentially from the first side A to the second side B, where m is a positive integer greater than 1 and smaller than n. A slit 11 in the m^{th} domain extends to a boundary line at the third side, so that a non-closed structure where the plurality of slits 11 and the plurality of branch electrodes 12 are arranged alternately is formed at the boundary line at the second side B. The third side is a side where a dark line is formed in the m^{th} domain.

Based on the above, the third side is a side where the dark line is formed in the m^{th} domain, and the slit 11 in the m^{th} domain extends to the boundary line at the third side. In this way, it is able to move the dark line to an outside of the domain, and enable the liquid crystal molecule in the m^{th} domain to be in a more stable state, thereby to improve the color offset and increase the transmittance.

It should be appreciated that, the m^{th} domain refers to any domain between the first domain S1 and the n^{th} domain. In some embodiments of the present disclosure, the slit 11 in any domain other than the first domain S1 and the n^{th} domain extends to the boundary line at the third side. For example, as shown in FIG. 13, the slits in the second domain S2 and the third domain S3 of the four domains extend to the boundary line at the third side (i.e., a left boundary line in FIG. 13).

For example, in the pixel unit as shown in FIG. 13, one subpixel is divided into four domains. When the slit 11 in the first domain S1 extends to the upper boundary line, the slit 11 in the fourth domain S4 extends to the lower boundary line and the alignment directions of the liquid crystal molecules in the second domain S2 and the third domain S3 are those shown in FIG. 5, the dark line may occur at the left boundary line in FIG. 13 in accordance with the alignment directions of the liquid crystal molecules. Hence, the slits 11 in the second domain S2 and the third domain S3 may extend to the left boundary line.

It should be appreciated that, FIG. 13 is merely for illustrative purposes, and in actual use, the boundary line at the third side is determined in accordance with the alignment directions of the liquid crystal molecules, but not limited to that in FIG. 13.

In addition, in some embodiments of the present disclosure, at least one slit 11 in the m^{th} domain extends to a boundary line at a fourth side, so that a non-closed structure where the plurality of slits 11 and the plurality of branch electrodes 12 are arranged alternately is formed at the boundary line at the second side B. Based on the above, the slit 11 in the m^{th} domain may extend to the boundary line at the fourth side.

Of course, in some other embodiments of the present disclosure, as shown in FIG. 13, the m^{th} domain is provided at the boundary line at the fourth side with a domain-edge main electrode 14 extending in the first direction Y. Based on the above, there is no dark line at the fourth side in the m^{th} domain, so the domain-edge main electrode 14 may be arranged at the boundary line at the fourth side.

In addition, in the pixel unit according to one embodiment of the present disclosure, at least one of the pixel electrode or the common electrode is the slit electrode 10. In other words, the slit 11 is formed in the pixel electrode or the common electrode, or both.

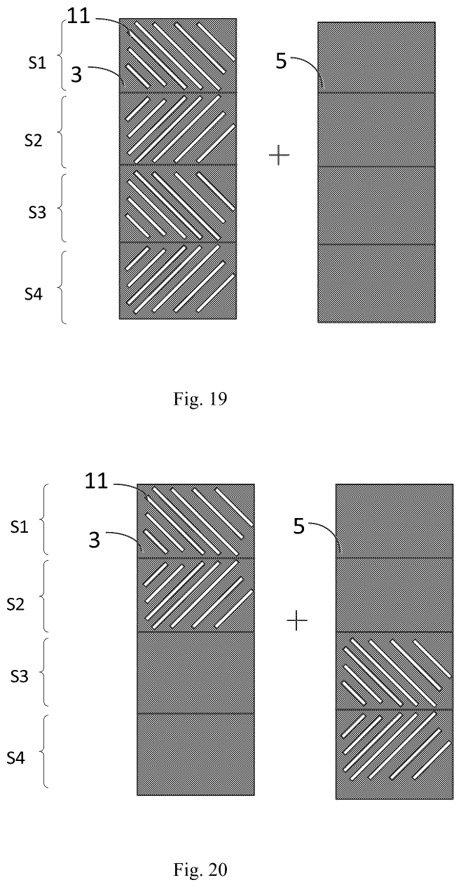

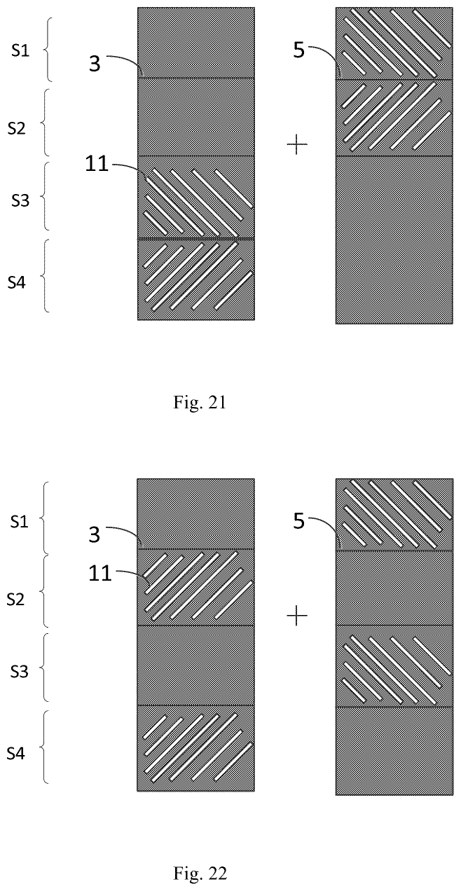

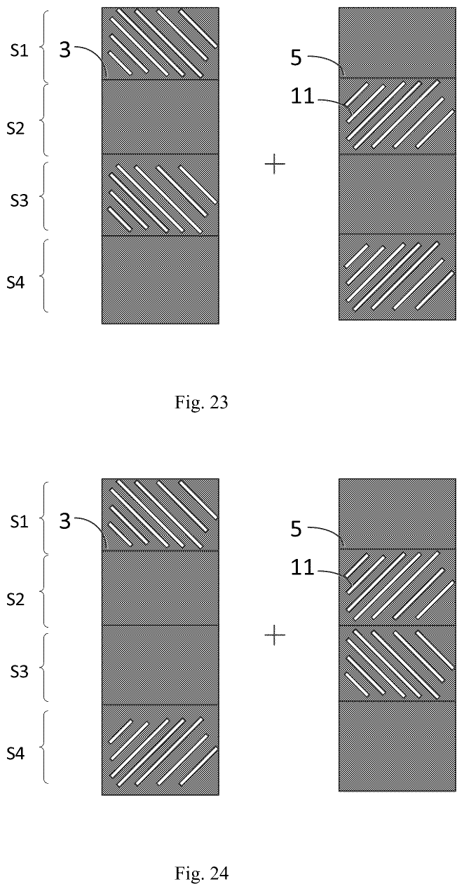

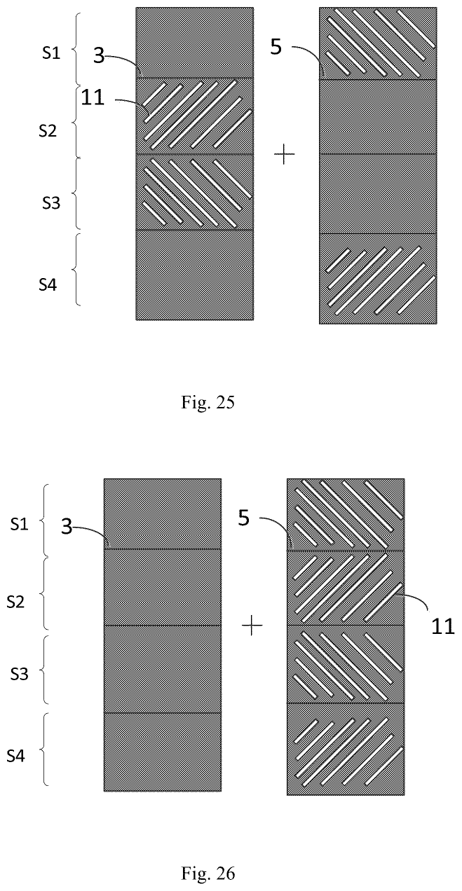

The pixel electrode is arranged on the array substrate, and the common electrode is arranged on the color film substrate, as shown in FIGS. 19 to 26.

In some embodiments of the present disclosure, the pixel electrode is the slit electrode 10, and it is provided with the slit 11 in each domain. The common electrode is not provided with any slit 11 in each domain.

In some other embodiments of the present disclosure, the slit electrode 10 includes both the pixel electrode and the common electrode. When there are four domains, the pixel electrode is provided with the slits 11 in the first domain S1 and the second domain S2, and the common electrode is provided with the slits 11 in the third domain S3 and the fourth domain S4. When the array substrate is arranged opposite to the color film substrate to form a cell, the pixel electrode is combined with the common electrode so as to provide the slits 11 in each domain.

In some other embodiments of the present disclosure, the slit electrode 10 includes both the pixel electrode and the common electrode. When there are four domains, the pixel electrode is provided with the slits 11 in the third domain S3 and the fourth domain S4, and the common electrode is provided with the slits 11 in the first domain S1 and the second domain S2. When the array substrate is arranged opposite to the color film substrate to form a cell, the pixel electrode is combined with the common electrode so as to provide the slits 11 in each domain.

In some other embodiments of the present disclosure, the slit electrode 10 includes both the pixel electrode and the common electrode. When there are four domains, the pixel electrode is provided with the slits 11 in the first domain S1 and the third domain S3, and the common electrode is provided with the slits 11 in the second domain S2 and the fourth domain S4. When the array substrate is arranged opposite to the color film substrate to form a cell, the pixel electrode is combined with the common electrode so as to provide the slits 11 in each domain.

In some other embodiments of the present disclosure, the slit electrode 10 includes both the pixel electrode and the common electrode. When there are four domains, the pixel electrode is provided with the slits 11 in the second domain S2 and the fourth domain S4, and the common electrode is provided with the slits 11 in the first domain S1 and the third domain S3. When the array substrate is arranged opposite to the color film substrate to form a cell, the pixel electrode is combined with the common electrode so as to provide the slits 11 in each domain.

In some other embodiments of the present disclosure, the slit electrode 10 includes both the pixel electrode and the common electrode. When there are four domains, the pixel electrode is provided with the slits 11 in the first domain S1 and the fourth domain S4, and the common electrode is provided with the slits 11 in the second domain S2 and the third domain S3. When the array substrate is arranged opposite to the color film substrate to form a cell, the pixel electrode is combined with the common electrode so as to provide the slits 11 in each domain.

In some other embodiments of the present disclosure, the slit electrode 10 includes both the pixel electrode and the common electrode. When there are four domains, the pixel electrode is provided with the slits 11 in the second domain S2 and the third domain S3, and the common electrode is provided with the slits 11 in the first domain S1 and the fourth domain S4. When the array substrate is arranged opposite to the color film substrate to form a cell, the pixel electrode is combined with the common electrode so as to provide the slits 11 in each domain.

In some other embodiments of the present disclosure, the common electrode is the slit electrode 10, and it is provided with the slit in each domain. The pixel electrode is not provided with any slit in each domain.

It should be appreciated that, the above is merely for illustrative purposes, and in actual use, the slits 11 may be formed in the pixel electrode and the common electrode in any other ways, which will not be particularly defined herein.

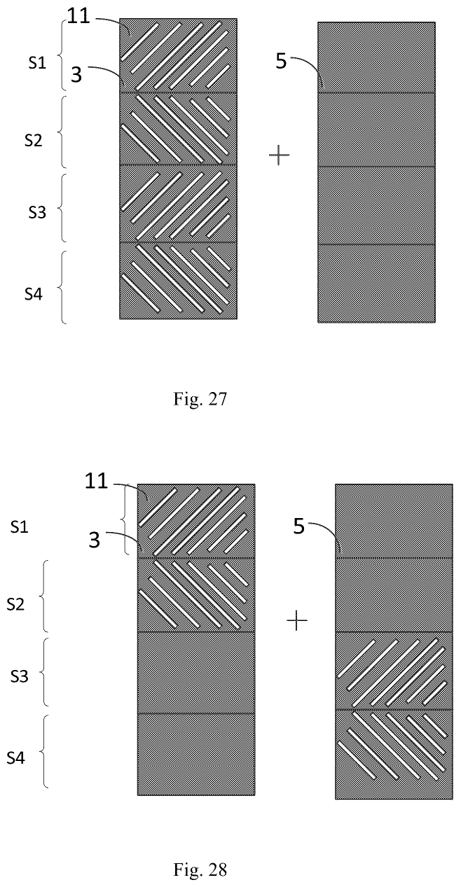

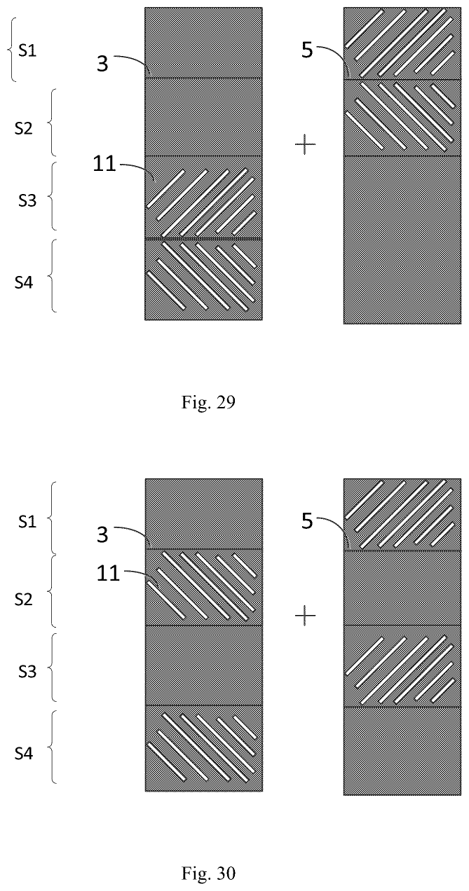

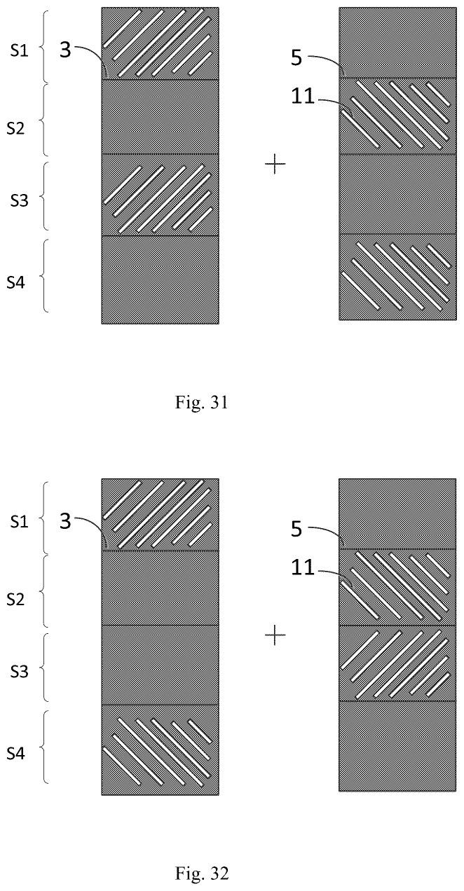

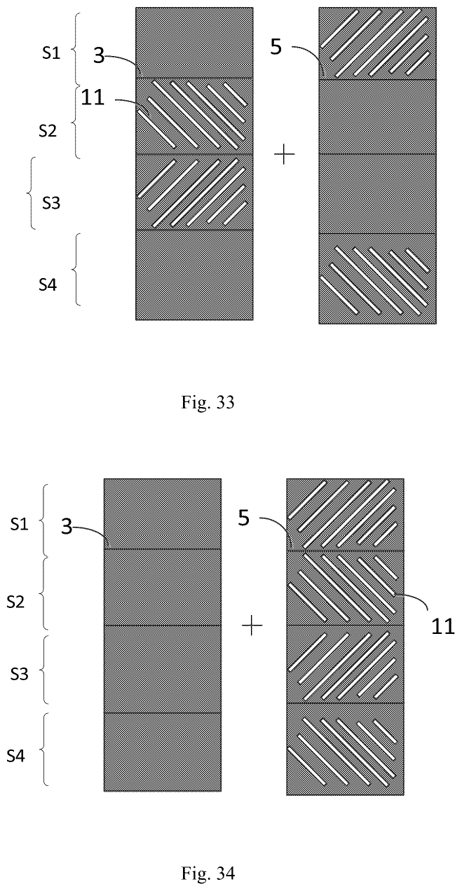

In addition, it should be further appreciated that, the tilt direction of the slit 11 in the pixel in FIGS. 19 to 26 is merely for illustrative purposes. In some other embodiments of the present disclosure, as shown in FIGS. 27 to 34, the tilt direction of the slit 11 is in mirror symmetry with the tilt direction of the slit 11 in FIGS. 19 to 26 relative to the first direction Y.

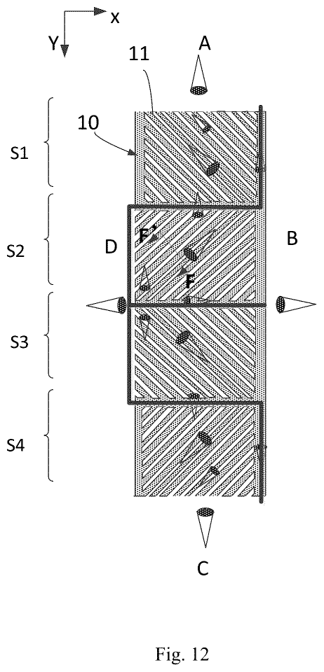

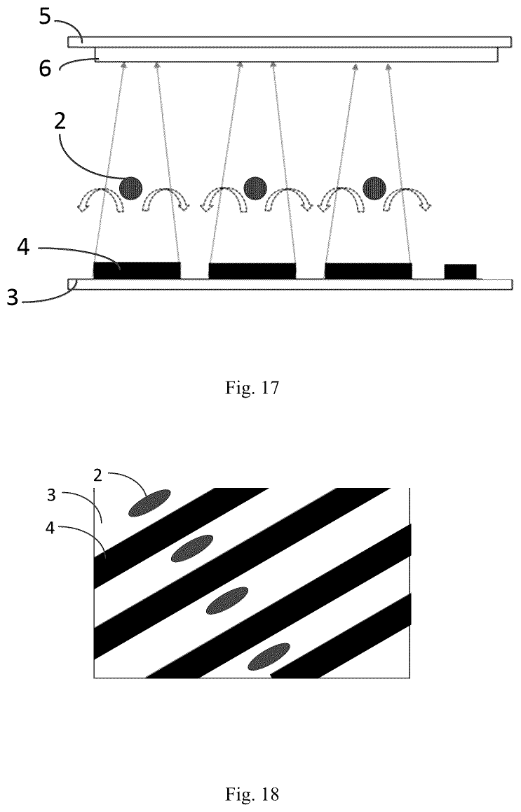

FIG. 17 shows an electric field force in the second domain S2 of the pixel unit in FIG. 12 which shows the deflection of the liquid crystal molecules in the second domain S2, and FIG. 18 is a top view of the electric field force in FIG. 17. When the alignment film is formed on the color film substrate 5, the liquid crystal molecule 2 is deflected in accordance with the direction of the alignment force, and the pixel electrode 4 on the array substrate 3 serves as the slit electrode 10. The liquid crystal molecules 2 are rotated under the effect of the alignment force applied by the second alignment layer 6 on the color film substrate 5 and the electric field force applied by the slit electrode on the array substrate 3, and the four domains are formed in accordance with rotation states of the liquid crystal molecules.

The above description relates to a configuration mode of the alignment direction of the alignment film on one or both of the first substrate and the second substrate as well as the slit in the display panel where each sub-pixel includes n domains in the first direction Y, so as to enable the alignment azimuth angle of the liquid crystal molecule is greater than or equal to 30 and smaller than 45, thereby to improve the color offset.

In the related art, the domains in the display panel are arranged in the other ways. Another configuration mode of the alignment direction of the alignment film and the slit electrode will be described hereinafter so as to implement the display panel in the embodiments of the present disclosure.

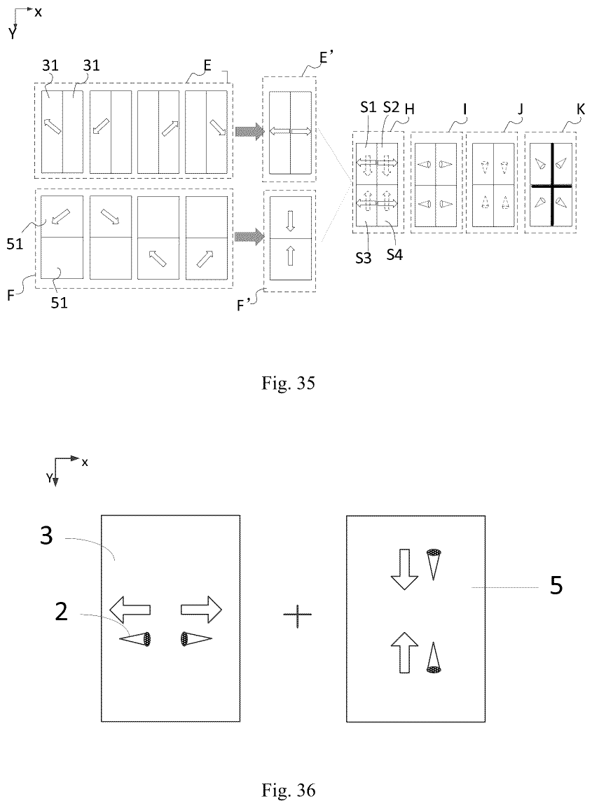

In the related art, as shown in FIG. 35, the alignment is performed on the alignment film on the display panel through another process. The alignment film is exposed for alignment through polarized light generated by the WGP, and when there is no slit electrode, the azimuth angle of the liquid crystal molecule and the dark like are poor. As shown in FIG. 35, in the process, each of the color film substrate and the array substrate needs to be subjected to four WGP exposures. Taking a dotted box E in FIG. 35 as an example, the array substrate includes two first sub-regions 31 in the second direction X, and each first sub-region 31 is subjected to double exposures, i.e., the array substrate needs to be subjected to four WGP exposures. An exposure order of the first sub-regions will not be particularly defined herein. After the exposures, the alignment directions in the two first sub-regions 31 of the array substrate are angled relative to the second direction X by 0° and opposite to each other (as shown in the dotted box E′ in FIG. 3). Taking a dotted box F in FIG. 35 as an example, the color film substrate includes two second sub-regions 51 in the first direction Y, and each second sub-region 51 is subjected to double exposures, i.e., the color film substrate needs to be subjected to four WGP exposures. An exposure order of the second sub-regions will not be particularly defined herein. After the exposures, the alignment directions in the two second sub-regions 51 of the color film substrate are angled relative to the first direction Y by 0° and opposite to each other (as shown in the dotted box F′ in FIG. 35). A dotted box H in FIG. 5 shows the alignment directions in the domains after the color film substrate is attached to the array substrate. Dotted boxes I to K in FIG. 35 show rotation directions of the liquid crystal molecules and the dark lines, where a black thick line indicates the dark line. As shown in the dotted box K in FIG. 35, a horizontal dark line and a longitudinal dark line are formed on the display panel in a criss-cross form. A width of the dark line is relatively large, and a pattern of the dark line is not optimum, i.e., it is in a twisted state as a whole. Due to the accuracy of the alignment azimuth angles of the liquid crystal molecules at two sides of each of the color film substrate and the array substrate, there is a difference between the alignment azimuth angle of the liquid crystal molecule in the domain and the predetermined angle, so the criss-cross dark lines occur and the transmittance is adversely affected.

In some other embodiments of the present disclosure, a first alignment film is arranged on the first substrate, a second alignment film is arranged on the second substrate, and the n domains are arranged in an M*N form in the first direction Y and the second direction X, where M*N=n. The first alignment film is divided into N first sub-regions 31 in the second direction X, the second alignment film is divided into M second sub-regions 51 in the first direction Y, the alignment directions in the N first sub-regions 31 are the second direction X, the alignment directions in the two adjacent first sub-regions 31 are opposite to each other, the alignment directions in the M second sub-regions 51 are the first direction Y, and the alignment directions in the two adjacent second sub-regions 51 are opposite to each other, so that the first alignment film and the second alignment film are provided with different alignment directions in the n domains.

Based on the above, the plurality of domains in each sub-pixel of the display panel is arranged in an array form. As shown in FIG. 35, a dotted box E shows the four exposures in the two first sub-regions 31 on the array substrate, a dotted box E′ shows the alignment directions of the alignment film on the array substrate, a dotted box F shows the four exposures in the two second sub-regions 51 on the color film substrate, a dotted box F′ shows the alignment directions of the alignment film on the color film substrate, a dotted box H shows the alignment forces after the array substrate is attached to the color film substrate, a dotted box I shows the deflection of the liquid crystal molecules at a side of the array substrate, a dotted box J shows the deflection of the liquid crystal molecules at a side of the color film substrate, and a dotted box K shows an intermediate state of the liquid crystal molecules and the dark lines.

As shown in FIG. 35, the sub-pixel includes four domains arranged in a 2*2 form in the first direction Y and the second direction X, and the four domains include a first domain S1 in a first row and a first column, a second domain S2 in the first row and a second column, a third domain S3 in a second row and the first column, and a fourth domain S4 in the second row and the second column. A first boundary line extending in the first direction Y or a second boundary line extending in the second direction X is arranged among the first domain S1, the second domain S2, the third domain S3 and the fourth domain S4, the alignment directions of the alignment forces applied by the first alignment film and the second alignment film in the first domain S1, the second domain S2, the third domain S3 and the fourth domain S4 are in mirror symmetry relative to the first boundary line or the second boundary line.

After the color film substrate is attached to the array substrate, the dotted box I in FIG. 35 shows the deflection of the liquid crystal molecules at a side of the array substrate, the doted box J in FIG. 35 shows the deflection of the liquid crystal molecules at a side of the color film substrate, and the dotted box K in FIG. 35 shows the intermediate state of the liquid crystal molecules and the dark lines. In addition, the pretilt angles of the liquid crystal molecules in the first domain S1 and the second domain S2, in the second domain S2 and the fourth domain S4, are in mirror symmetry relative to the first boundary line or the second boundary line.

In the embodiments of the present disclosure, the alignment force generated by both the first alignment film and the second alignment film is applied to the liquid crystal molecule, so as to provide the liquid crystal molecule with the pretilt angle (i.e., the alignment azimuth angle) greater than or equal to 30° and smaller than 45°.

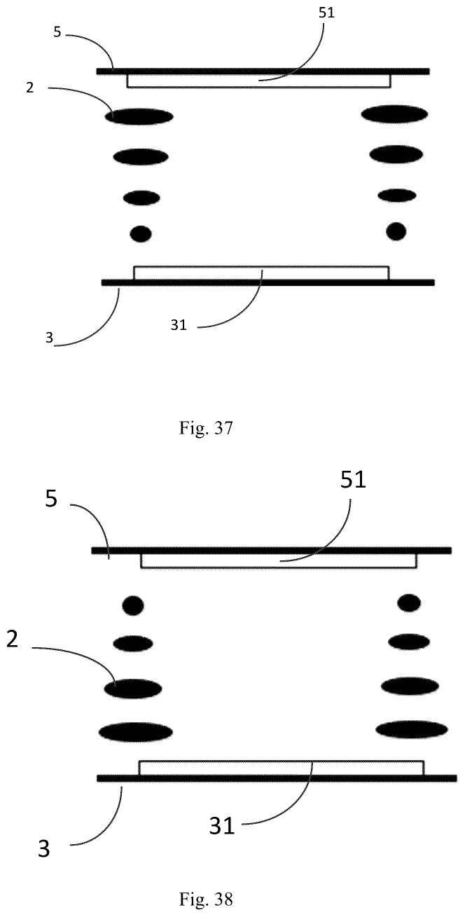

In some embodiments of the present disclosure, as shown in FIG. 36, each of the first electrode on the first substrate and the second electrode on the second substrate is not provided with any slit. At this time, the alignment azimuth angles of the liquid crystal molecules on surfaces of the first substrate and the second substrate are controlled by the alignment force applied by the alignment film. FIG. 37 is a side sectional view of the pixel after the first substrate is attached to the second substrate, and FIG. 38 is a front sectional view of the pixel. There is a difference between the alignment azimuth angle of the liquid crystal molecule in the domain and the pretilt angle, and the accuracy of the alignment azimuth angle of the liquid crystal molecule is poor, so the criss-cross dark line is displayed and the transmittance is adversely affected.

In order to further increase the transmittance, thin the dark line and optimize the optical characteristics, in some other embodiments of the present disclosure, a first electrode is arranged on the first substrate and a second electrode is arranged on the second substrate. The first electrode is provided with slits and at least a part of the slits extend in the second direction X, and/or the second electrode is provided with slits and at least a part of the slits extend in the first direction Y.

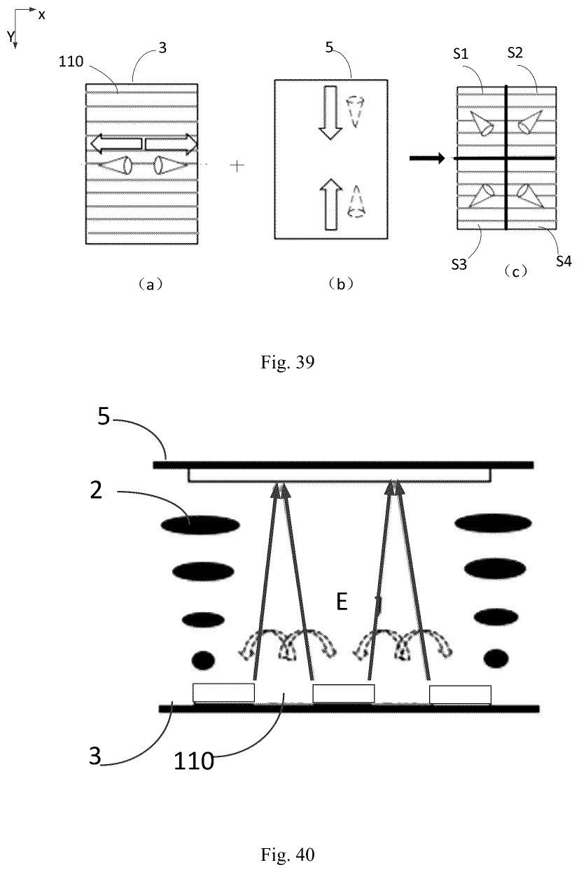

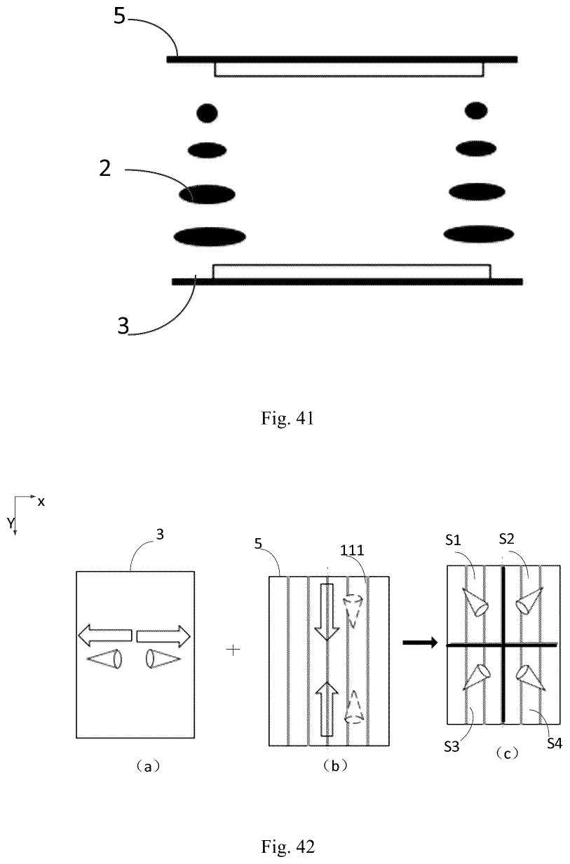

To be specific, in a possible embodiment of the present disclosure, as shown in FIG. 39(a), the first electrode on the first substrate 3 is a slit electrode, and it is provided with a plurality of first slits 110 extending in the second direction X, i.e., the first slits 110 extend in a direction substantially parallel to the alignment direction of the first alignment film on the first substrate 3. As shown in FIG. 39(b), the second electrode on the second substrate 5 is not provided with any slit. At this time, FIG. 39(c) shows the alignment directions and the direction of the liquid crystal molecules after the first substrate 3 is attached to the second substrate 5, FIG. 40 is a left-side sectional view of the pixel in FIG. 39(c) after the first substrate 3 is attached to the second substrate 5, and FIG. 41 is a front sectional view of the pixel, where E represents the electric field force. At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner In addition, after obtaining the accurate alignment azimuth angle of the liquid crystal molecule at a side of the first substrate 3, it is able to reduce a difference between the alignment azimuth angle of the liquid crystal molecule in a twisted nematic mode and a target azimuth angle, thereby to thin the dark line.

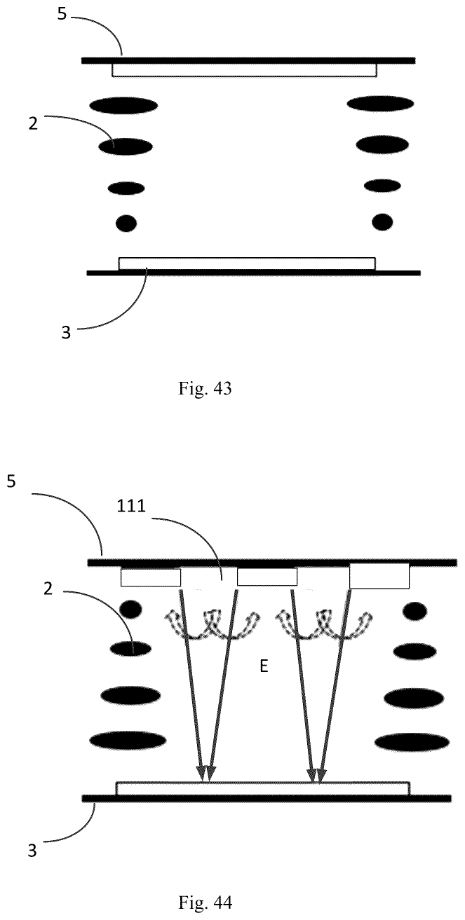

In another possible embodiment of the present disclosure, as shown in FIG. 42(b), the second electrode on the second substrate 5 is a slit electrode, and it is provided with a plurality of second slits 111 extending in the first direction Y, i.e., the second slits 111 extend in a direction substantially parallel to the alignment direction of the second alignment film on the second substrate 5. As shown in FIG. 42(a), the first electrode on the first substrate 3 is not provided with any slit. At this time, FIG. 42(c) shows the alignment directions and the directions of the liquid crystal molecules after the first substrate 3 is attached to the second substrate 5, FIG. 43 is a left-side sectional view of the pixel in FIG. 42(c) after the first substrate 3 is attached to the second substrate 5, and FIG. 44 is a front sectional view of the pixel in FIG. 42(c), where E represents the electric field force. At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the first substrate 3, it is able to reduce a difference between the alignment azimuth angle of the liquid crystal molecule in the twisted nematic mode and the target azimuth angle, thereby to thin the dark line.

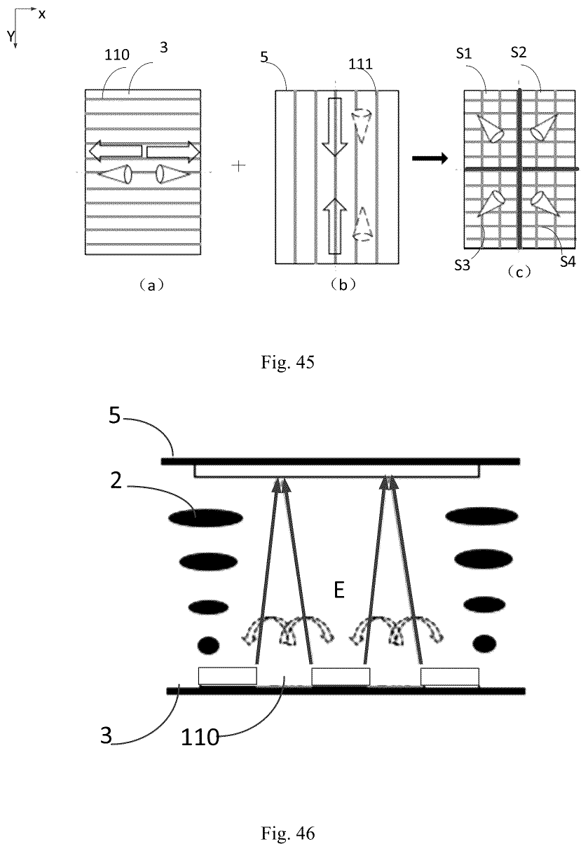

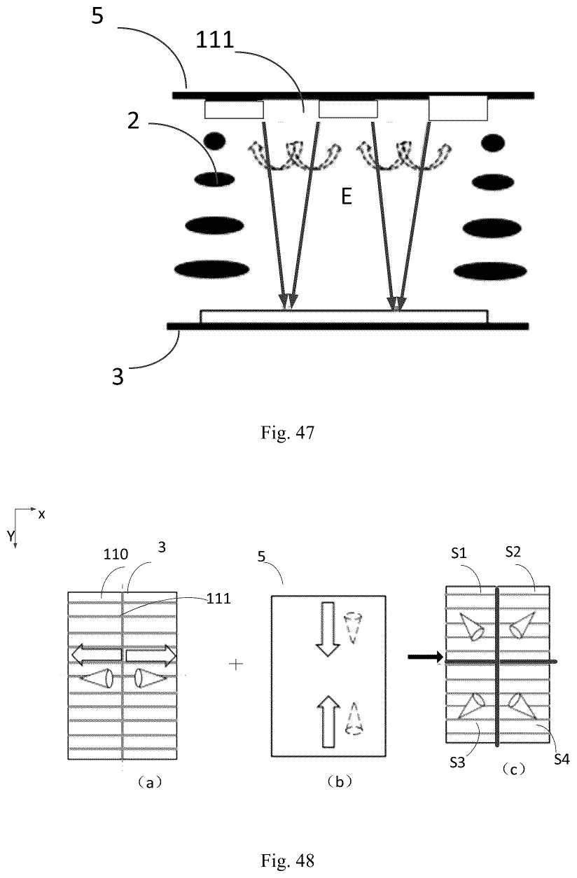

In yet another possible embodiment of the present disclosure, as shown in FIG. 45(a), the first electrode on the first substrate 3 is a slit electrode, and it is provided with a plurality of first slits 110 extending in the second direction X, i.e., the first slits 110 extend in a direction substantially parallel to the alignment direction of the first alignment film on the first substrate 3. As shown in FIG. 45(b), the second electrode on the second substrate 5 is a slit electrode, and it is provided with a plurality of second slits 111 extending in the first direction Y, i.e., the second slits 111 extend in a direction substantially parallel to the alignment direction of the second alignment film on the second substrate 5. At this time, FIG. 45(c) shows the alignment directions and the directions of the liquid crystal molecules after the first substrate 3 is attached to the second substrate 5, FIG. 46 is a left-side sectional view of the pixel in the display panel in FIG. 45(c) after the first substrate 3 is attached to the second substrate 5, and FIG. 47 is a front sectional view of the pixel in FIG. 45(c) after the first substrate 3 is attached to the second substrate 5, where E represents the electric field force. At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the first substrate 3, it is able to reduce a difference between the alignment azimuth angle of the liquid crystal molecule in the twisted nematic mode and the target azimuth angle, thereby to thin the dark line.

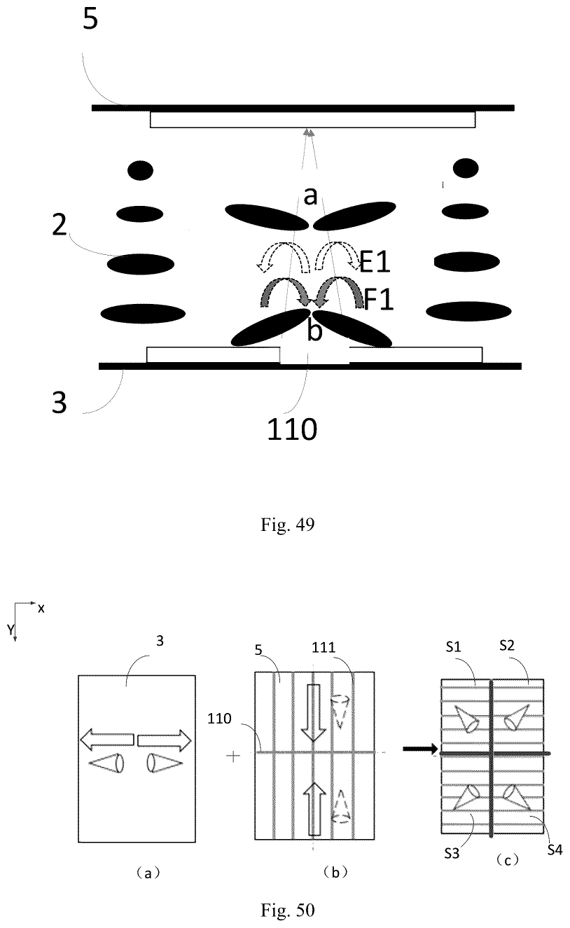

In still yet another possible embodiment of the present disclosure, as shown in FIG. 48(a), the first electrode on the first substrate 3 is a slit electrode, and it is provided with a plurality of first slits 110 extending in the second direction X and a second slit 111 extending in the first direction Y and located at a center of the sub-pixel. In other words, the first substrate 3 is provided with not only the first slits 110 extending in a direction parallel to the alignment direction of the first alignment film, but also the second slit 111 located at the center of the sub-pixel and extending in a direction perpendicular to the alignment direction of the first alignment film. As shown in FIG. 48(b), the second electrode on the second substrate 5 is not provided with any slit. At this time, FIG. 48(c) shows the alignment directions and the directions of the liquid crystal molecules after the first substrate 3 is attached to the second substrate 5, and FIG. 49 is a left-side sectional view of the pixel in the display panel in FIG. 48(a) after the first substrate 3 is attached to the second substrate 5. At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the first substrate 3, it is able to reduce a difference between the alignment azimuth angle of the liquid crystal molecule in the twisted nematic mode and the target azimuth angle, thereby to thin the dark line. As compared with that in FIG. 39, in the embodiments of the present disclosure, the additional second slit 111 extending in a direction perpendicular to the direction of the alignment force of the first alignment film is provided, so the electric field force is generated by the first electrode in a direction perpendicular to the direction of the alignment force, thereby the liquid crystal molecules are in an instable state and a dark line region is relatively large due to the interaction. As shown in FIG. 49, a rotation direction a of the liquid crystal molecule under the effect of the electric field force is perpendicular to a rotation direction b of the liquid crystal molecule under the effect of the alignment force, so the liquid crystal molecule is in an instable state and a dark line region is relatively large due to the interaction. Hence, when the first electrode on the first substrate 3 is provided with the slits and the second electrode on the second substrate 5 is not provided with any slit, the second slit 111 is preferably not provided.

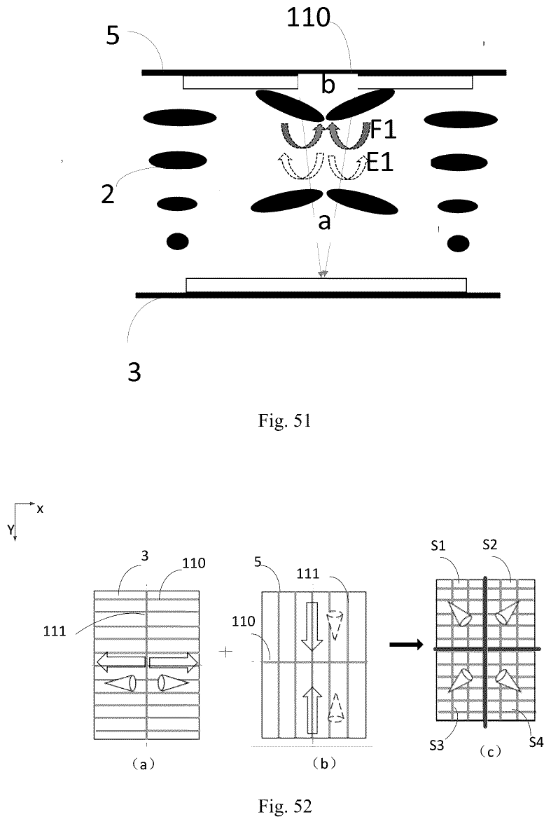

In still yet another possible embodiment of the present disclosure, as shown in FIG. 50(b), the second electrode on the second substrate 5 is a slit electrode, and it is provided with a plurality of second slits 111 extending in the second direction X and a first slit 110 extending in the first direction Y and located at a center of the sub-pixel. In other words, the second substrate 5 is provided with not only the second slits 111 extending in a direction parallel to the alignment direction of the second alignment film, but also the first slit 110 located at the center of the sub-pixel and extending in a direction perpendicular to the alignment direction of the second alignment film. As shown in FIG. 50(a), the first electrode on the first substrate 3 is not provided with any slit. At this time, FIG. 50(c) shows the directions of the alignment force and the alignment directions of the liquid crystal molecules after the first substrate 3 is attached to the second substrate 5, and FIG. 51 is a left-side sectional view of the pixel in the display panel in FIG. 50(c) after the first substrate 3 is attached to the second substrate 5. At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the second substrate 5, it is able to reduce a difference between the alignment azimuth angle of the liquid crystal molecule in the twisted nematic mode and the target azimuth angle, thereby to thin the dark line. As compared with that in FIG. 42, in the embodiments of the present disclosure, due to the additional first slit 110, the electric field force is generated in a direction parallel to the direction of the alignment force, thereby the liquid crystal molecules are in a stable state and a dark line region is relatively small due to the interaction. As shown in FIG. 51, a rotation direction a of the liquid crystal molecule under the effect of the electric field force is parallel to a rotation direction b of the liquid crystal molecule under the effect of the alignment force, so the liquid crystal molecule is in a stable state and a dark line region is relatively small due to the interaction. Hence, when the second electrode on the second substrate 5 is provided with the slits, it may be provided with not only the plurality of second slits 111 extending in a direction parallel to the alignment direction on the second substrate 5 but also the first slit 110 passing through the center of the sub-pixel and extending in a direction perpendicular to the direction of the alignment force.

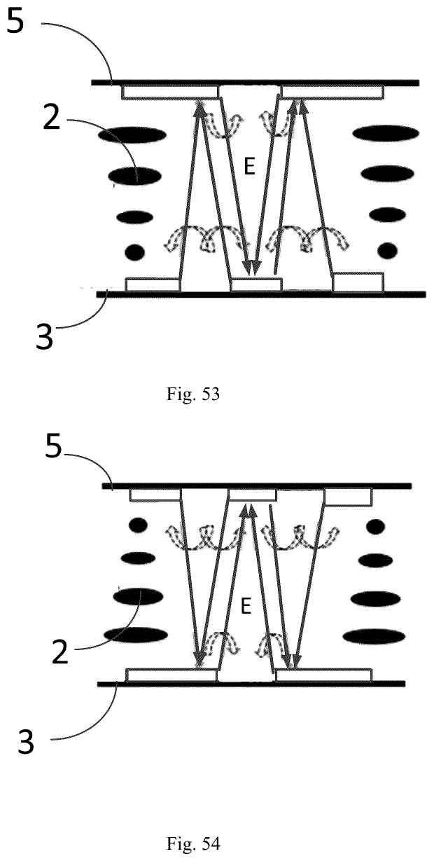

In still yet another possible embodiment of the present disclosure, as shown in FIG. 52(a), both the first electrode on the first substrate 3 and the second electrode on the second substrate 5 are provided with slits, the first electrode is provided with a plurality of first slits 110 extending in the second direction X and a second slit 111 located at a center of the sub-pixel and extending in a direction perpendicular to the alignment direction of the first alignment film. In other words, the second substrate 5 is provided with not only the plurality of first slits 110 parallel to the alignment direction of the first alignment film but also the second slit 111 located at the center of the sub-pixel and extending in a direction perpendicular to the alignment direction of the first alignment film. As shown in FIG. 52(b), the second electrode is provided with a plurality of second slits 110 extending in the first direction Y and a first slit 110 located at a center of the sub-pixel and extending in the second direction X. In other words, the second substrate 5 is provided with not only the second slits 111 extending in a direction parallel to the alignment direction of the second alignment film, but also the first slit 110 located at the center of the sub-pixel and extending in a direction perpendicular to the alignment direction of the second alignment film. At this time, FIG. 52(c) shows the alignment directions and the alignment directions of the liquid crystal molecules after the first substrate 3 is attached to the second substrate 5, FIG. 53 is a left-side sectional view of the pixel in the display panel in FIG. 52(c) after the first substrate 3 is attached to the second substrate 5, and FIG. 54 is a front sectional view of the pixel in the display panel in FIG. 52(c). At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the second substrate 5, it is able to reduce a difference between the alignment azimuth angle of the liquid crystal molecule in the twisted nematic mode and the target azimuth angle, thereby to thin the dark line. In the embodiments of the present disclosure, due to the additional first slit 110, the electric field force is generated in a direction parallel to the direction of the alignment force, thereby the liquid crystal molecules are in a stable state and a dark line region is relatively small due to the interaction. As shown in FIGS. 53 and 54, at the second slit 111 on the first substrate 3 located at the center of the sub-pixel, a rotation direction a of the liquid crystal molecule under the effect of the electric field force is perpendicular to a rotation direction b of the liquid crystal molecule under the effect of the alignment force, so the liquid crystal molecule is in an instable state, a dark line region is relatively large and the longitudinal dark line is not perfect due to the interaction. At the first slit 110 on the second substrate 5 located at the center of the sub-pixel, the rotation direction a of the liquid crystal molecule under the effect of the electric field force is parallel to the rotation direction b of the liquid crystal molecule under the effect of the alignment force, so the liquid crystal molecule is in a stable state, the dark line region is relatively small and the horizontal dark line is perfect due to the interaction.

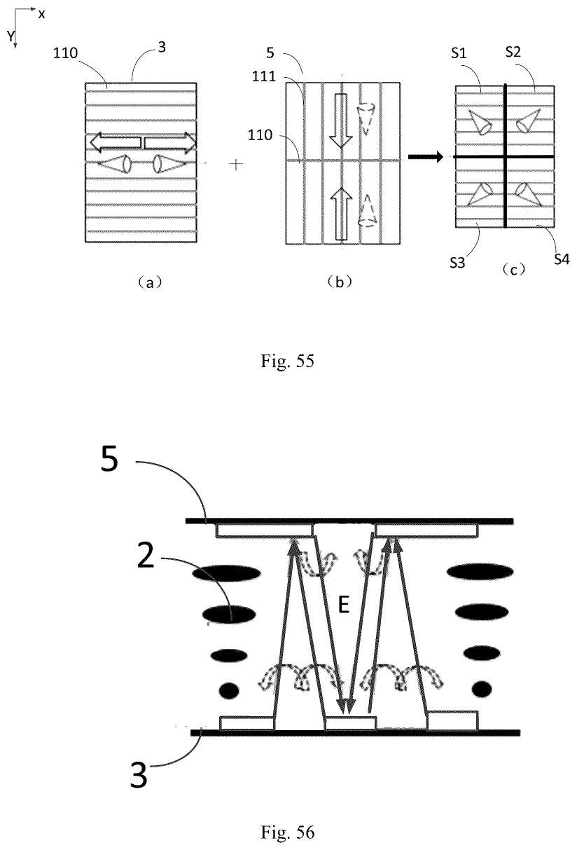

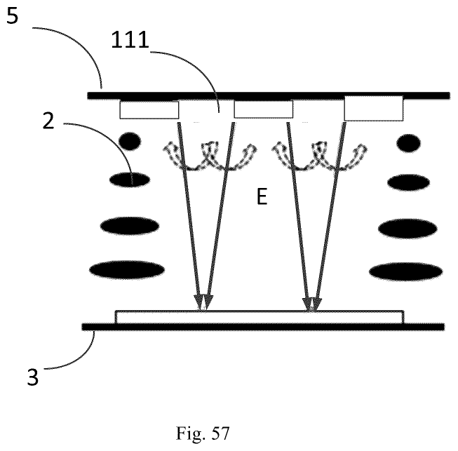

In still yet another possible embodiment of the present disclosure, as shown in FIG. 55(a), both the first electrode on the first substrate 3 and the second electrode on the second substrate 5 are provided with slits, the first electrode is provided with a plurality of first slits 110 extending in the second direction X but without any second slit 111 located at a center of the sub-pixel and extending in the first direction Y. In other words, the second substrate 5 is merely provided with the plurality of first slits 110 parallel to the alignment direction of the first alignment film. As shown in FIG. 55(b), the second electrode is provided with a plurality of second slits 111 extending in the first direction Y and a first slit 110 located at a center of the sub-pixel and extending in the second direction X. In other words, the second substrate 5 is provided with not only the plurality of second slits 111 parallel to the alignment direction of the second alignment film but also the first slit 110 located at the center of the sub-pixel and extending in a direction perpendicular to the alignment direction of the second alignment film. At this time, FIG. 55(c) shows the alignment directions and the directions of the liquid crystal molecules after the first substrate 3 is attached to the second substrate 5, FIG. 56 is a left-side sectional view of the pixel in the display panel in FIG. 52(c) after the first substrate 3 is attached to the second substrate 5, and FIG. 57 is a front sectional view of the pixel in the display panel in FIG. 52(c). At this time, the alignment azimuth angle of the liquid crystal molecule on the surface of the first substrate 3 is controlled by the alignment force applied by the first alignment film as well as the electric field force generated by the first electrode and the second electrode, so as to obtain a fundamental azimuth angle in a more accurate manner. In addition, after obtaining the accurate alignment azimuth angle of the liquid crystal molecule at a side of the second substrate 5, it is able to reduce a difference between the alignment azimuth angle of the liquid crystal molecule in the twisted nematic mode and the target azimuth angle, thereby to thin the dark line. In the embodiments of the present disclosure, the first substrate 3 is not provided with any second slit 111 extending in a direction perpendicular to the alignment direction, and the second substrate 5 is provided with the first slit 110 extending in a direction perpendicular to the alignment direction. At this time, the generated electric field force is parallel to the direction of the alignment force, so the liquid crystal molecule is in a stable state and the dark line region is relatively small under the interaction.

In addition, it should be appreciated that, the tilt directions of the slits 11 in the pixel in FIGS. 39 to 58 are for illustrative purposes only. In some other embodiments of the present disclosure, the tilt direction of the slit 11 may be in mirror symmetry with those shown in FIGS. 39 to 58 relative to the first direction Y.

In addition, the display panel in the embodiments of the present disclosure may be, but not limited to, a VA display panel.

The present disclosure further provides in some embodiments a display device including the above-mentioned display panel.

The present disclosure further provides in some embodiments a method for manufacturing the above-mentioned display panel. The display panel includes a plurality of pixel units, each pixel unit includes at least two sub-pixels in different colors, each sub-pixel includes n domains, n is a positive integer greater than or equal to 2, and at least two of the n domains are arranged in a first direction. The method includes: forming a first substrate 3 and a second substrate 5, an alignment film being arranged on one or both of the first substrate 3 and the second substrate 5 and provided with alignment directions, and/or slit electrodes each with a slit being arranged on one or both of the first substrate 3 and the second substrate 5; and injecting liquid crystal molecules into between the first substrate 3 and the second substrate 5 and enabling the first substrate 3 to be arranged opposite to the second substrate 5 to form a cell, to form the display panel. The alignment directions in at least two adjacent domains in the n domains are different and/or extension directions of the slits in any two adjacent domains are different, so that the liquid crystal molecules in different domains are provided with different pretilt angles. The predetermined angle is an acute angle between a pretilt angle of the liquid crystal molecule and a second direction X, the predetermined angle is greater than or equal to 30° and smaller than 45°, and the second direction intersects the first direction.

For example, when the n domains are arranged sequentially in the first direction, the forming the first substrate 3 and the second substrate 5 specifically includes: providing a first base substrate, forming a first optical alignment material layer on the first base substrate, and subjecting each domain in the first optical alignment material layer to double exposures through polarized light so that the first optical alignment material layer forms a first alignment film with alignment directions. An angle between the alignment direction of the alignment film formed through a first exposure and the second direction X is 0°, and an acute angle between the alignment direction of the alignment film formed through a second exposure and the second direction X is 45°.

For example, when the n domains are arranged sequentially in the first direction, the forming the first substrate 3 and the second substrate 5 specifically includes: providing a second base substrate, forming a second optical alignment material layer on the second base substrate, and subjecting each domain in the second optical alignment material layer to double exposures through polarized light so that the second optical alignment material layer forms a second alignment film with alignment directions. An angle between the alignment direction of the alignment film formed through a first exposure and the second direction X is 0°, and an acute angle between the alignment direction of the alignment film formed through a second exposure and the second direction X is 45°.

For example, in the first exposure, light passes through a first polarizer to form the polarized light so as to expose the first optical alignment material layer and/or the second optical alignment material layer at exposure energy of 1 Mj to 7 Mj, the first polarizer is a polarization beam splitter, and the angle between the alignment direction and the second direction X is 0°. In the second exposure, light passes through a second polarizer to form the polarized light so as to expose the first optical alignment material layer and/or the second optical alignment material layer at exposure energy of 10 Mj to 30 Mj, the second polarizer is a grid-type splitting polarizer, and the acute angle between the alignment direction and the second direction X is 45°.

Some description will be given as follows.

(1) The drawings merely relate to structures involved in the embodiments of the present disclosure, and the other structures may refer to those known in the art.

(2) For clarification, in the drawings for describing the embodiments of the present disclosure, a thickness of a layer or region is zoomed out or in, i.e., these drawings are not provided in accordance with an actual scale. It should be appreciated that, in the case that such an element as layer, film, region or substrate is arranged “on” or “under” another element, it may be directly arranged “on” or “under” the other element, or an intermediate element may be arranged therebetween.

(3) In the case of no conflict, the embodiments of the present disclosure and the features therein may be combined to acquire new embodiments.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A display panel, comprising a first substrate and a second substrate arranged opposite to each other to form a cell, and liquid crystal molecules arranged between the first substrate and the second substrate, wherein the display panel comprises a plurality of pixel units, each pixel unit comprises at least two sub-pixels in different colors, each sub-pixel comprises n domains, n is a positive integer greater than or equal to 2, and at least two of the n domains are arranged in a first direction;
an alignment film is arranged on one or both of the first substrate and the second substrate and provided with alignment directions, and/or slit electrodes each with a slit are arranged on one or both of the first substrate and the second substrate;
alignment directions in at least two adjacent domains in the n domains are different and/or extension directions of slits in any two adjacent domains are different, so that liquid crystal molecules in different domains are provided with different pretilt angles; and
the pretilt angle is an acute angle between a tilt angle of the liquid crystal molecule and a second direction, the pretilt angle is greater than or equal to 30° and smaller than 45°, and the second direction intersects the first direction.

2. The display panel according to claim 1, wherein the n domains are arranged sequentially along the first direction, and an acute angle between an alignment direction in each domain and the second direction is greater than or equal to 30° and smaller than 45°.

3. The display panel according to claim 2, wherein the alignment film is formed in each domain by double exposures, an angle between an alignment direction of the alignment film formed through a first exposure of the double exposures and the second direction is 0°, and an accurate angle between an alignment direction of the alignment film formed through a second exposure of the double exposures and the second direction is 45°.

4. The display panel according to claim 2, wherein each sub-pixel comprises four domains including a first domain, a second domain, a third domain and a fourth domain arranged sequentially in the first direction, alignment directions of at least two adjacent domains are different, and alignment directions of the four domains are in mirror symmetry relative to a boundary line between the second domain and the third domain in the second direction.

5. The display panel according to claim 2, wherein extension directions of slits in any two adjacent domains in the n domains are different, an acute angle between the extension direction of the slit in each domain and the second direction is a predetermined angle, the predetermined angle is greater than or equal to 30° and smaller than or equal to 45°, and an angle between the alignment direction of the alignment film in each domain and the extension direction of the slit in the domain is smaller than or equal to a predetermined value.

6. The display panel according to claim 4, wherein the predetermined value is 0° to 15°.

7. The display panel according to claim 1, wherein a first alignment film is arranged on the first substrate, a second alignment film is arranged on the second substrate, and the n domains are arranged in an M*N array in the first direction and the second direction, where M*N=n; and the first alignment film is divided into N first sub-regions in the second direction, the second alignment film is divided into M second sub-regions in the first direction, the alignment directions in the N first sub-regions are the second direction, the alignment directions in the two adjacent first sub-regions are opposite to each other, the alignment directions in the M second sub-regions are the first direction, and the alignment directions in the two adjacent second sub-regions are opposite to each other, so that the first alignment film and the second alignment film are provided with different alignment directions in the n domains.

8. The display panel according to claim 7, wherein the sub-pixel comprises four domains arranged in a 2*2 array in the first direction and the second direction, and the four domains comprise a first domain in a first row and a first column, a second domain in the first row and a second column, a third domain in a second row and the first column, and a fourth domain in the second row and the second column; and
a first boundary line extending in the first direction and a second boundary line extending in the second direction are arranged among the first domain, the second domain, the third domain and the fourth domain, and the pretilt angles of the liquid crystal molecules in the first domain, the second domain, the third domain and the fourth domain are in mirror symmetry relative to the first boundary line or the second boundary line.

9. The display panel according to claim 7, wherein a first electrode is arranged on the first substrate, and a second electrode is arranged on the second substrate; and
the first electrode is provided with slits and at least a part of the slits extend in the second direction, and/or the second electrode is provided with slits and at least a part of the slits extend in the first direction.

10. The display panel according to claim 9, wherein the first electrode is provided with a plurality of first slits extending in a direction parallel to the alignment direction of the first alignment film and the second electrode is not provided with any slit; or
the second electrode is provided with a plurality of second slits extending in a direction parallel to the alignment direction of the second alignment film and the first electrode is not provided with any slit; or
the first electrode is provided with the plurality of first slits extending in the direction parallel to the alignment direction of the first alignment film, and the second electrode is provided with the plurality of second slits extending in the direction parallel to the alignment direction of the second alignment film; or
the first electrode is provided with the plurality of first slits extending in the direction parallel to the alignment direction of the first alignment film and one second slit extending in the direction perpendicular to the alignment direction of the first alignment film and passing through a center of the sub-pixel, and the second electrode is not provided with any slit; or
the second electrode is provided with the plurality of second slits extending in the direction parallel to the alignment direction of the second alignment film and one first slit extending in the direction perpendicular to the alignment direction of the second alignment film and passing through the center of the sub-pixel, and the first electrode is not provided with any slit; or
the first electrode is provided with the plurality of first slits extending in the direction parallel to the alignment direction of the first alignment film and one second slit extending in the direction perpendicular to the alignment direction of the first alignment film and passing through the center of the sub-pixel, and the second electrode is provided with the plurality of second slits extending in the direction parallel to the alignment direction of the second alignment film and one first slit extending in the direction perpendicular to the alignment direction of the second alignment film and passing through the center of the sub-pixel; or
the first electrode is provided with the plurality of first slits extending in the direction parallel to the alignment direction of the first alignment film, and the second electrode is provided with the plurality of second slits extending in the direction parallel to the alignment direction of the second alignment film and one first slit extending in the direction perpendicular to the alignment direction of the second alignment film and passing through the center of the sub-pixel.

11. The display panel according to claim 1, wherein the display panel is a vertical-alignment display panel.

12. A display device, comprising the display panel according to claim 1.

13. A method for manufacturing the display panel according to claim 1, wherein the display panel comprises the plurality of pixel units, each pixel unit comprises at least two sub-pixels in different colors, each sub-pixel comprises n domains, n is a positive integer greater than or equal to 2, and at least two of the n domains are arranged in the first direction,
wherein the method comprises:
forming the first substrate and the second substrate, the alignment film being arranged on one or both of the first substrate and the second substrate and provided with alignment directions, and/or slit electrodes each with a slit are arranged on one or both of the first substrate and the second substrate; and
injecting liquid crystal molecules into between the first substrate and the second substrate, enabling the first substrate to be arranged opposite to the second substrate to form a cell, to form the display panel,
wherein the alignment directions in at least two adjacent domains in the n domains are different and/or extension directions of the slits in any two adjacent domains are different, so that the liquid crystal molecules in different domains are provided with different pretilt angles; and
the pretilt angle is an acute angle between the tilt angle of the liquid crystal molecule and the second direction, the pretilt angle is greater than or equal to 30° and smaller than 45°, and the second direction intersects the first direction.

14. The method according to claim 13, wherein when the n domains are arranged sequentially in the first direction, the forming the first substrate and the second substrate specifically comprises:
providing a first base substrate, forming a first optical alignment material layer on the first base substrate, and subjecting each domain in the first optical alignment material layer to double exposures through polarized light so that the first optical alignment material layer forms the first alignment film with alignment directions, an angle between the alignment direction of the alignment film formed through a first exposure and the second direction being 0°, and an acute angle between the alignment direction of the alignment film formed through a second exposure and the second direction being 45°; and/or
providing a second base substrate, forming a second optical alignment material layer on the second base substrate, and subjecting each domain in the second optical alignment material layer to double exposures through polarized light so that the second optical alignment material layer forms a second alignment film with alignment directions, an angle between the alignment direction of the alignment film formed through a first exposure and the second direction being 0°, and an acute angle between the alignment direction of the alignment film formed through a second exposure and the second direction being 45°.

15. The method according to claim 14, wherein in the first exposure, light passes through a first polarizer to form the polarized light so as to expose the first optical alignment material layer and/or the second optical alignment material layer at exposure energy of 1 Mj to 7 Mj, the first polarizer is a polarization beam splitter, and the angle between the alignment direction and the second direction is 0°; and
in the second exposure, light passes through a second polarizer to form the polarized light so as to expose the first optical alignment material layer and/or the second optical alignment material layer at exposure energy of 10 Mj to 30 Mj, the second polarizer is a grid-type splitting polarizer, and the angle between the alignment direction and the second direction is 45°.
